(19) United States
(12) Patent Application Publication
(10) Pub. No.: US 2023/0410181 A1
(43) Pub. Date: Dec. 21, 2023

(54) INFORMATION PROCESSING METHOD, INFORMATION PROCESSING SYSTEM, AND PROGRAM

(71) Applicant: FUJIFILM Corporation, Tokyo (JP)

(72) Inventors: Masahiro SATO, Tokyo (JP); Tomoki Taniguchi, Tokyo (JP); Tomoko Ohkuma, Tokyo (JP)

(73) Assignee: FUJIFILM Corporation, Tokyo (JP)

(21) Appl. No.: 18/333,552

(22) Filed: Jun. 13, 2023

(30) Foreign Application Priority Data
Jun. 15, 2022 (JP) 2022-096849

(51) Int. Cl. G06Q 30/0601

(52) U.S. Cl. CPC G06Q 30/0631

(57) ABSTRACT

Provided are an information processing method, an information processing system, and a program capable of generating a suggested item list that is robust against the domain shift by applying a plurality of models that are trained by using datasets of domains different from an introduction destination domain. The information processing system is configured to: acquire one or more candidate items from each of a plurality of models trained by using datasets in one or more domains different from an introduction destination domain; and select, from among a plurality of the acquired candidate items, a plurality of candidate items having different domains from each other as suggested items and generate a suggested item list that is a suggested item list including a plurality of the suggested items and that has robust performance against a domain shift.

### CROSS-REFERENCE TO RELATED APPLICATION

The present application claims priority under 35 U.S.C. § 119(a) to Japanese Patent Application No. 2022-096849 filed on Jun. 15, 2022, which is hereby expressly incorporated by reference, in its entirety, into the present application.

### BACKGROUND OF THE INVENTION

### 1. Field of the Invention

The present invention relates to an information processing method, an information processing system, and a program.

### 2. Description of the Related Art

It is difficult for a user to select the best item that suits him/herself from many items in terms of time and cognitive ability. For example, in the case of a user of the EC site, the item is a product handled by the EC site, and in the case of a user of a document information management system, the item is the stored document information.

Dietmar Jannach, Markus Zanker, Alexander Felfernig, Gerhard Friedrich, translated by Katsumi Tanaka, Kazutoshi Kakutani “Introduction to Information Suggestion System-Theory and Practice-” Kyoritsu Publishing Co., Ltd., 2012 and Deepak K. Agarwal, Bee-Chung Chen, “Suggestion System: Theory and Practice of Statistical Machine Learning,” Kyoritsu Publishing Co., Ltd., 2018 discloses research related to an information suggestion technique, which is a technique for presenting a selection candidate from among items for the purpose of assisting selection of a user. The EC of the EC site is an abbreviation for Electronic Commerce.

Generally, an information suggestion system performs a training based on data collected at an introduction destination facility. However, in a case where the information suggestion system is introduced in a facility different from the facility corresponding to learning data, there is a problem that the prediction accuracy of the model is decreased. The problem that a machine learning model does not work well at unknown other facilities is called domain shift, and research related to domain generalization, which is research on improving robustness against the domain shift, has been active in recent years, mainly in image recognition as described in Jindong Wang, Cuiling Lan, Chang Liu, Yidong Ouyang, and Tao Qin, “Generalizing to Unseen Domains: A Survey on Domain Generalization” Microsoft Research, Beijing, China, 2021 and Kaiyang Zhou, Ziwei Liu, Yu Qiao, Tao Xiang, and Chen Change Loy “Domain Generalization in Vision: A Survey” Central University of Finance and Economics, Beijing, China, 2021. However, in the information suggestion technique, there is no research case for domain generalization.

In a case where a learning model, which is applied to the information suggestion system, is trained, even in a case where data of the introduction destination facility of the information suggestion system cannot be obtained, it is possible to select the best learning model from among a plurality of candidate learning models by using the data and evaluating the learning model in a case where the data of the introduction destination facility is obtained in a case where the information suggestion system is introduced.

However, in a case where data of the introduction destination facility is not present even in a case where the learning model is introduced, or in a case where access to the data of the introduction destination facility is not possible even in a case where the data of the introduction destination facility is present, it is difficult to select the best learning model from among the plurality of candidate learning models described above.

Zheng Xu, Wen Li, Li Niu, and Dong Xu “Exploiting Low-rank Structure from Latent Domains for Domain Generalization” School of Computer Engineering, Nanyang Technological University, Singapore, 2014 discloses a suggestion technique that aims at prediction robust against domain shifts by using an average value of each of prediction results for learning model corresponding to each of a plurality of domains.

Michael Jahrer, Andreas Toscher, and Robert Legenstein “Combining predictions for accurate recommender systems”, 2010 discloses, for example, a method of combining a plurality of predictions, such as applying an average value of a plurality of predictions, to try to improve the prediction accuracy for a collaborative filtering model, which is a type of prediction model in the information suggestion technique.

### SUMMARY OF THE INVENTION

However, even in an evaluation before the introduction of the information suggestion system to which the learning model is applied, it is difficult to provide the best information suggestion system for the introduction destination facility based on the data of the introduction destination facility in a case where the data of the introduction destination facility of the suggestion system cannot be used. However, even in a case where a facility corresponding to the learning data and the introduction destination facility are different, there is a demand to realize high performance information suggestion that is robust against the domain shift and which is the introduction destination facility.

The suggestion technique described in Zheng Xu, Wen Li, Li Niu, and Dong Xu “Exploiting Low-rank Structure from Latent Domains for Domain Generalization” School of Computer Engineering, Nanyang Technological University, Singapore, 2014 is a method assuming image processing and is not suitable for the information suggestion technique. Specifically, the information suggestion technique described in Zheng Xu, Wen Li, Li Niu, and Dong Xu “Exploiting Low-rank Structure from Latent Domains for Domain Generalization” School of Computer Engineering, Nanyang Technological University, Singapore, 2014 is premised on an output of a single prediction and is not suitable for the information suggestion technique that outputs a plurality of predictions.

In the method disclosed in Michael Jahrer, Andreas Toscher, and Robert Legenstein “Combining predictions for accurate recommender systems”, 2010, a plurality of collaborative filtering models are trained by using data of the same domain and are not robust against the domain shift. Further, the method disclosed in Michael Jahrer, Andreas Toscher, and Robert Legenstein “Combining predictions for accurate recommender systems”, 2010 does not aim at domain generalization.

The present invention has been made in view of such circumstances, and an object is to provide an information processing method, an information processing system, and a program capable of generating a suggested item list that is robust against the domain shift by applying a plurality of models that are trained by using datasets of domains different from an introduction destination domain.

An information processing method according to a first aspect of the present disclosure of causing an information processing system, which includes one or more processors, to generate a suggested item list for suggesting a plurality of items to a user, the information processing method comprises: causing the information processing system to execute: acquiring one or more candidate items from each of a plurality of models trained by using datasets in one or more domains different from an introduction destination domain; and selecting, from among a plurality of the acquired candidate items, a plurality of the candidate items having different domains from each other as suggested items and generating a suggested item list that is a suggested item list including a plurality of the suggested items and that has robust performance against a domain shift.

According to the information processing method according to the first aspect, a suggested item list that is robust against the domain shift can be generated by applying the plurality of models, which are trained by using the dataset of the domain different from the introduction destination domain.

An example of the introduction destination includes an introduction destination facility. A facility is a group in which a plurality of users behave. Examples of the facility include a company or an EC site.

In the information processing method of a second aspect according to the information processing method of the first aspect, the information processing system may be configured to: calculate a prediction value obtained by predicting a user behavior with respect to each of the candidate items; and select the suggested item from the plurality of candidate items based on an order of statistical values calculated by using the prediction value of the same candidate item in each of a plurality of domains different from the introduction destination domain.

According to such an aspect, the suggested item can be selected from among the plurality of candidate items based on the prediction value for each candidate item.

An example of the prediction value that predicts the user behavior includes a probability that the user performs a positive behavior.

In the information processing method of a third aspect according to the information processing method of the first or second aspect, the information processing system may be configured to: derive an evaluation value obtained in accordance with a closeness of attributes between the introduction destination domain and each of a plurality of domains, for each of a plurality of candidate lists that are candidates for the suggested item list; and define the candidate list for which a minimum value of the evaluation values is the largest, as the suggested item list.

According to such an aspect, the suggested item list can be selected from among the plurality of candidate lists based on the evaluation value of the candidate list.

In the information processing method of a fourth aspect according to the information processing method of the third aspect, the information processing system may be configured to calculate, assuming that a user behavior is positive on the candidate item of the model trained by using data of a domain having an attribute close to an attribute of the introduction destination domain and assuming that the user behavior is negative on the candidate item of the model trained by using data of a domain having an attribute distant from the attribute of the introduction destination domain, the evaluation value for each of the candidate lists by deterministically simulating the user behavior.

According to such an aspect, the suggested item list can be selected from among the plurality of candidate lists based on the evaluation value calculated by deterministically simulating the user behavior.

In the information processing method of a fifth aspect according to the information processing method of the third aspect, the information processing system may be configured to calculate, assuming that a user behavior is positive with a first probability on the candidate item of the model trained by using a dataset of a domain having an attribute close to an attribute of the introduction destination domain as learning data and assuming that the user behavior is positive with a second probability on the candidate item of the model trained by using a dataset of a domain having an attribute distant from the attribute of the introduction destination domain as learning data, the evaluation value for each of the candidate lists by probabilistically simulating the user behavior.

According to such an aspect, the suggested item list can be selected from among the plurality of candidate lists based on the evaluation value calculated by probabilistically simulating the user behavior.

In the information processing method of a sixth aspect according to the information processing method of the fifth aspect, the information processing system may be configured to: estimate the first probability by using an evaluation result obtained by evaluating each of the plurality of models in a first domain to which the dataset is applied as the learning data; and estimate the second probability by using an evaluation result obtained by evaluating each of a plurality of models in a second domain different from the first domain.

In the information processing method of a seventh aspect according to the information processing method of the third aspect, the information processing system may be configured to calculate the evaluation value based on a user behavior in a case where the candidate list is presented to the user in the introduction destination domain.

In the information processing method of an eighth aspect according to the information processing method of any one of the third to seventh aspects, the information processing system may be configured to calculate the evaluation value for each of the candidate lists by applying a weight that is a weight defined for each of the candidate items according to an order of the candidate item included in the candidate list and that is defined according to an evaluation condition.

According to such an aspect, the evaluation value, which is obtained in accordance with the weight of each candidate item, can be calculated.

In the information processing method of a ninth aspect according to the information processing method of any one of the third to eighth aspects, the information processing system may be configured to select one or more of the candidate items from each of the plurality of the candidate lists.

According to such an aspect, the candidate items having different sources are selected as the suggested items.

Thereby, constant robust performance against the domain shift in the suggested item list can be ensured.

In the information processing method of a tenth aspect according to the information processing method of any one of the first to eighth aspects, the information processing system may be configured to select the candidate item to be the suggested item with a priority given to the dissimilar candidate list from among the plurality of candidate lists.

According to such an aspect, the selection of the suggested item from each of the plurality of candidate lists similar to each other is avoided. Thereby, constant robust performance against a domain shift in a plurality of suggested items can be ensured.

In such an aspect, the similarity degree of the models may be calculated, and the similarity or dissimilarity of the candidate items may be determined based on the similarity of the models.

In the information processing method of an eleventh aspect according to the information processing method of any one of the first to eighth aspects, the information processing system may be configured to change, in a case where a plurality of presentations of the suggested item list are performed to the same user, an arrangement order of the plurality of suggested items included in the suggested item list for each of the presentations.

According to such an aspect, constant averaging can be realized for the suggested item list in each presentation.

In the information processing method of a twelfth aspect according to the information processing method of any one of the first to eighth aspects, the information processing system may be configured to change, in a case where a plurality of presentations of the suggested item list are performed, an arrangement order of the plurality of suggested items included in the suggested item list for each of the presentations.

In such an aspect, the arrangement order of the plurality of suggested items may be changed for each user.

In the information processing method of a thirteenth aspect according to the information processing method of any one of the first to twelfth aspects, the information processing system may be configured to apply, as the plurality of models, a trained model that is trained by using datasets in different domains from each other as learning data.

According to such an aspect, each of the plurality of models depends on a different domain. Thereby, constant robust performance against the domain shift in the suggested item list can be ensured.

In the information processing method of a fourteenth aspect according to the information processing method of the first aspect, the information processing system may be configured to apply, as a plurality of models, a trained model that is trained by using feature sets different from each other in one domain different from the introduction destination domain as learning data.

According to such an aspect, even in a case where it is difficult to obtain data sets of different domains, the candidate items can be acquired from the plurality of models having different learning data. Thereby, constant robust performance against the domain shift in the suggested item list can be ensured.

An information processing system according to a fifteenth aspect of the present disclosure is an information processing system that generates a suggested item list for suggesting one or more items to a user, the information processing system comprises: one or more processors; and one or more memories in which a program executed by the one or more processors is stored, in which the one or more processors are configured to execute a command of the program to: acquire one or more candidate items from each of a plurality of models trained by using datasets in one or more domains different from an introduction destination domain; and select, from among a plurality of the acquired candidate items, a plurality of candidate items having different domains from each other as suggested items and generate a suggested item list that is a suggested item list including a plurality of the suggested items and that has robust performance against a domain shift.

According to the information processing system according to the fifteenth aspect, it is possible to obtain the same effects as the information processing method according to the first aspect. The constitutional requirements of the information processing method according to the second to fourteenth aspects can be applied to the constitutional requirements of the information processing apparatus according to the other aspects.

A program according to a sixteenth aspect of the present disclosure is a program for generating a suggested item list for suggesting one or more items to a user, the program causing a computer to realize: a function of acquiring one or more candidate items from each of a plurality of models trained by using datasets in one or more domains different from an introduction destination domain; and a function of selecting, from among a plurality of the acquired candidate items, a plurality of candidate items having different domains from each other as suggested items and generate a suggested item list that is a suggested item list including a plurality of the suggested items and that has robust performance against a domain shift.

According to the program according to the sixteenth aspect, it is possible to obtain the same effects as the information processing method according to the first aspect. The constitutional requirements of the information processing method according to the second to fourteenth aspects can be applied to the constitutional requirements of the program according to the other aspects.

According to the present invention, a suggested item list that is robust against the domain shift can be generated by applying the plurality of models, which are trained by using the dataset of the domain different from the introduction destination domain.

### BRIEF DESCRIPTION OF THE DRAWINGS

FIG. 1 is a conceptual diagram of a typical suggestion system.

FIG. 2 is a conceptual diagram showing an example of machine learning with a teacher that is widely used in building a suggestion system.

FIG. 3 is an explanatory diagram showing a typical introduction flow of the suggestion system.

FIG. 4 is an explanatory diagram of an introduction process of the suggestion system in a case where data of an introduction destination facility cannot be obtained.

FIG. 5 is an explanatory diagram in a case where a model is trained by domain adaptation.

FIG. 6 is an explanatory diagram of an introduction flow of the suggestion system including a step of evaluating the performance of the trained learning model.

FIG. 7 is an explanatory diagram showing an example of training data and evaluation data used for the machine learning.

FIG. 8 is a graph schematically showing a difference in performance of a model due to a difference in a dataset.

FIG. 9 is an explanatory diagram showing an example of an introduction flow of the suggestion system in a case where a learning domain and an introduction destination domain are different from each other.

FIG. 10 is an explanatory diagram showing a problem in a case where data of the introduction destination facility is not present.

FIG. 11 is a schematic diagram of a typical suggested item list.

FIG. 12 is a schematic diagram showing an evaluation result in a first example of a suggested item list evaluation.

FIG. 13 is a schematic diagram showing an evaluation result in a second example of the suggested item list evaluation.

FIG. 14 is an explanatory diagram of an outline of an information processing method according to an embodiment.

FIG. 15 is a schematic diagram showing a specific example of the suggested item list evaluation.

FIG. 16 is a schematic diagram showing another specific example of the suggested item list evaluation.

FIG. 17 is a block diagram schematically showing an example of a hardware configuration of an information processing system according to the embodiment.

FIG. 18 is a functional block diagram showing a functional configuration of the information processing system according to the embodiment.

FIG. 19 is a flowchart showing a procedure of the information processing method according to the embodiment.

FIG. 20 is a schematic diagram showing a suggested item list generation method according to a first embodiment.

FIG. 21 is a schematic diagram showing a suggested item list generation method according to a second embodiment.

FIG. 22 is a schematic diagram showing a suggested item list generation method according to a third embodiment.

FIG. 23 is a schematic diagram showing a suggested item list generation method according to a fourth embodiment.

FIG. 24 is a schematic diagram showing a suggested item list generation method according to a fifth embodiment.

FIG. 25 is a schematic diagram showing a suggested item list generation method according to a sixth embodiment.

FIG. 26 is a schematic diagram showing a suggested item list generation method according to a seventh embodiment.

FIG. 27 is a schematic diagram showing a suggested item list generation method according to an eighth embodiment.

FIG. 28 is a schematic diagram showing a suggested item list generation method according to a ninth embodiment.

FIG. 29 is a schematic diagram showing a suggested item list generation method according to a tenth embodiment.

FIG. 30 is a schematic diagram showing an example of a suggested item list generated by applying the suggested item list generation method according to an eleventh embodiment.

FIG. 31 is a schematic diagram showing another example of the suggested item list generated by applying the suggested item list generation method according to the eleventh embodiment.

FIG. 32 is an explanatory diagram of a first specific example of a plurality of models.

FIG. 33 is an explanatory diagram of a second specific example of the plurality of models.

FIG. 34 is a list of variables.

### DESCRIPTION OF THE PREFERRED EMBODIMENTS

Hereinafter, preferred embodiments of the present invention will be described with reference to the accompanying drawings. In the present specification, the same components are designated by the same reference numerals, and duplicate description thereof will be omitted as appropriate.

Overview of Information Suggestion Technique

In the present embodiment, a method of generating data of different domains related to user behavior history data used for a training and an evaluation of a model used in a suggestion system will be described. First, the outline of an information suggestion technique and the necessity of data of a plurality of domains will be overviewed by showing specific examples. The information suggestion technique is a technique for suggesting an item to a user. The suggestion may be referred to as a suggesting.

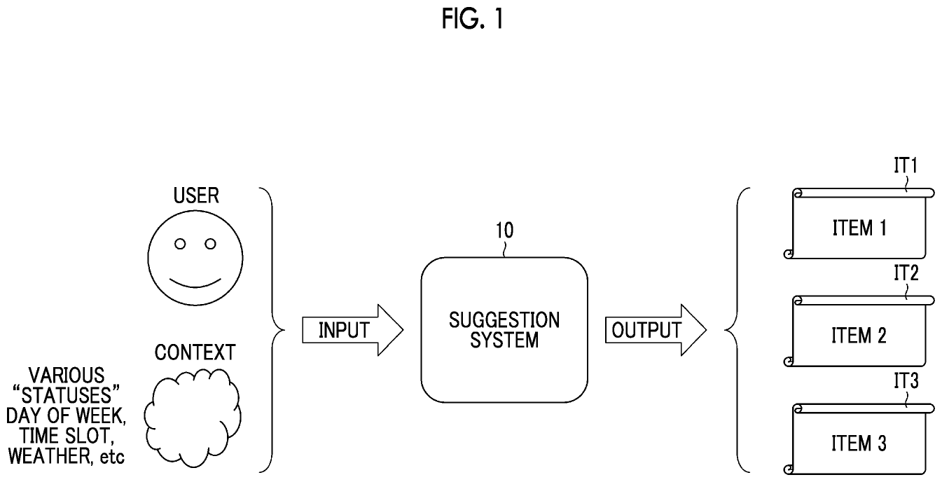

FIG. 1 is a conceptual diagram of a typical suggestion system. The suggestion system 10 receives user information and context information as inputs and outputs information of the item that is suggested to the user according to a context. The context means various statuses and may be, for example, a day of the week, a time slot, or the weather. The items may be various objects such as a book, a video, a restaurant, and the like.

The suggestion system 10 generally suggests a plurality of items at the same time. FIG. 1 shows an example in which a suggestion system 10 suggests three items of an item IT1, an item IT2, and an item IT3. In a case where the user responds positively to the suggested item IT1, item IT2, and item IT3, the suggestion is generally considered to be successful. A positive response is, for example, a purchase, browsing, and visit. Such a suggestion technique is widely used, for example, in an EC site, a gourmet site that introduces a restaurant, or the like.

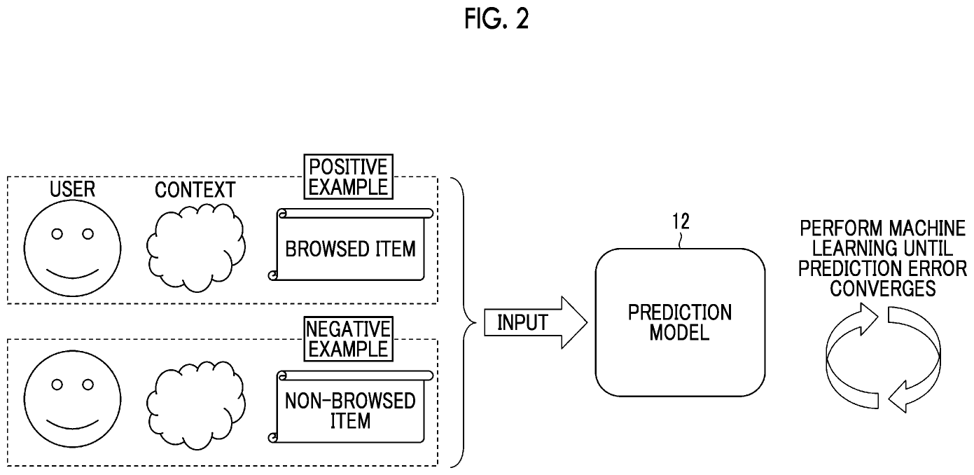

FIG. 2 is a conceptual diagram showing an example of machine learning with a teacher that is widely used in building a suggestion system. The suggestion system 10 is built by using a machine learning technique. Generally, a positive example and a negative example are prepared based on a user behavior history in the past, a combination of the user and the context is input to a prediction model 12, and the prediction model 12 is trained such that a prediction error becomes small. For example, a browsed item that is browsed by the user is defined as a positive example, and a non-browsed item that is not browsed by the user is defined as a negative example. The machine learning is performed until the prediction error converges, and the target prediction performance is acquired.

By using the trained prediction model 12, which is trained in this way, items with a high browsing probability, which is predicted with respect to the combination of the user and the context, are suggested. The trained prediction model 12 is synonymous with the trained-ended prediction model 12.

For example, in a case where a combination of a certain user A and a context β is input to the trained prediction model 12, the prediction model 12 infers that the user A has a high probability of browsing a document such as the item IT3 shown in FIG. 1 under a condition of the context β and suggests an item similar to the item IT3 to the user A. Depending on the configuration of the suggestion system 10, items are often suggested to the user without considering the context.

Example of Data Used for Developing Suggestion System

The user behavior history is equivalent to correct answer data in machine learning. Strictly speaking, it is understood as a task setting of inferring the next behavior from the past behavior history, but it is general to train the potential feature based on the past behavior history.

The user behavior history may include, for example, a book purchase history, a video browsing history, or a restaurant visit history.

Further, main feature include a user attribute and an item attribute. The user attribute may have various elements such as, for example, gender, age group, occupation, family structure, and residential area. The item attribute may have various elements such as a book genre, a price, a video genre, a length, a restaurant genre, and a place.

Model Building and Operation

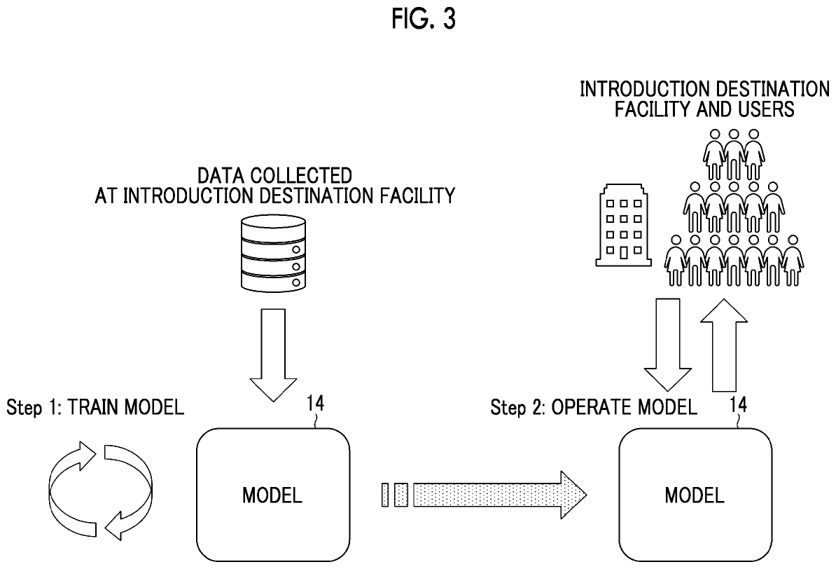

FIG. 3 is an explanatory diagram showing a typical introduction flow of the suggestion system. Here, a typical flow in a case where the suggestion system is introduced to a certain facility, is shown. The introduction of the suggestion system builds a model 14 for performing a target suggestion task as Step 1, and then introduces and operates the built model 14 as Step 2.

In the case of a machine learning model, the building of the model 14 includes training the model 14 by using training data to create a suggestion model, which is a prediction model that satisfies a practical level of suggestion performance. The operation of the model 14 is, for example, obtaining an output of a suggested item list from the trained model 14 with respect to the input of the combination of the user and the context.

Data for a training is required for building the model 14. As shown in FIG. 3, in general, the model 14 of the suggestion system is trained based on the data collected at an introduction destination facility. By performing training by using the data collected from the introduction destination facility, the model 14 learns the behavior of the user in the introduction destination facility and can accurately predict suggested items for the user in the introduction destination facility.

However, due to various circumstances, it may not be possible to obtain data on the introduction destination facility. For example, in the case of a document information suggestion system in an in-house system of a company or a document information suggestion system in an in-hospital system of a hospital, a company that develops a suggestion model may not be able to access the data of the introduction destination facility. In a case where the data of the introduction destination facility cannot be obtained, instead, it is necessary to perform training based on data collected at different facilities.

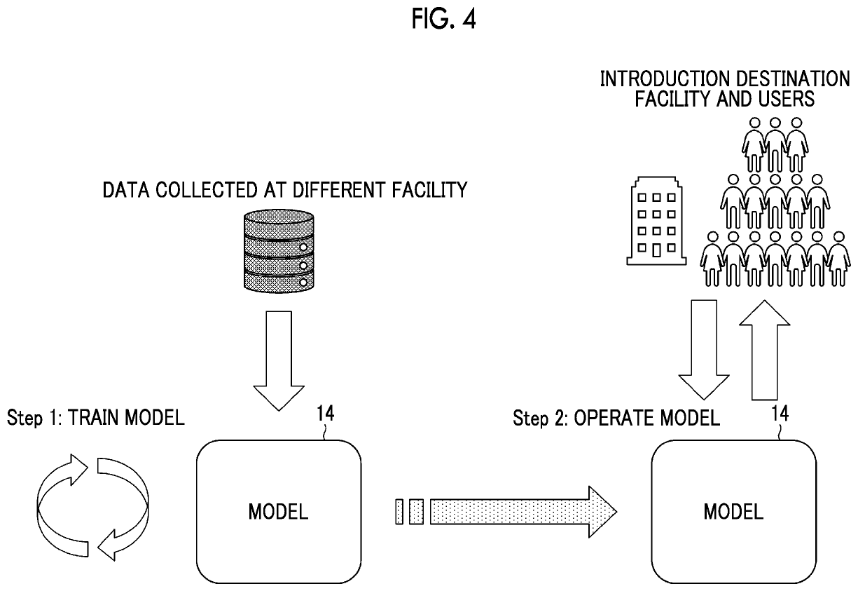

FIG. 4 is an explanatory diagram of an introduction process of the suggestion system in a case where data of an introduction destination facility cannot be obtained. In a case where the model 14, which is trained by using the data collected in a facility different from the introduction destination facility, is operated in the introduction destination facility, there is a problem that the prediction accuracy of the model 14 decreases due to differences in user behavior between facilities.

The problem that the machine learning model does not work well in unknown facilities different from the trained facility is understood as a technical problem, in a broad sense, to improve robustness against a problem of domain shift in which a source domain where the model 14 is trained differs from a target domain where the model 14 is applied. There is domain application as problem settings related to domain generalization. This is a method of training by using data from both the source domain and the target domain. The purpose of using the data of different domains in spite of the presence of the data of the target domain is to make up for the fact that the amount of data of the target domain is small and insufficient for a training.

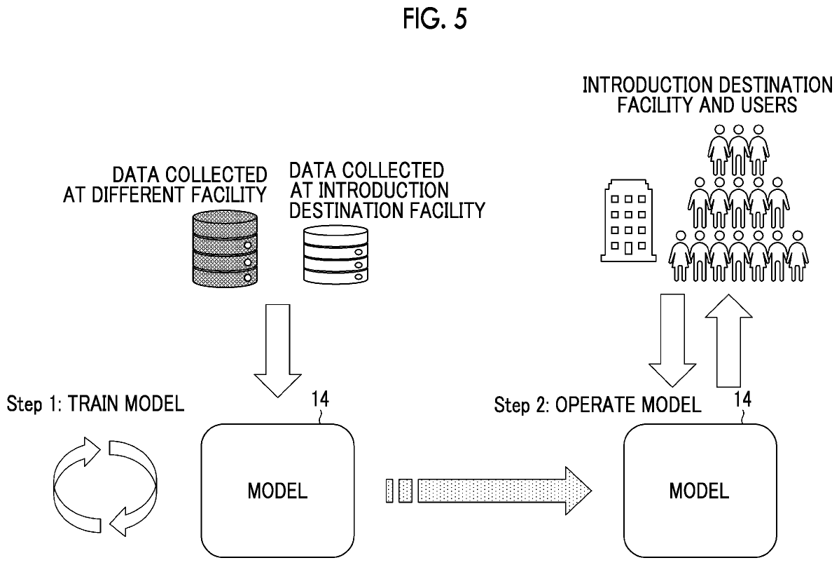

FIG. 5 is an explanatory diagram in a case where a model is trained by domain adaptation. Although the amount of data collected at the introduction destination facility that is the target domain is relatively smaller than the data collected at a different facility, the model 14 can also predict with a certain degree of accuracy the behavior of the users in the introduction destination facility by performing a training by using both data.

Description of Domain

The above-mentioned difference in a facility is a kind of difference in a domain. In Ivan Cantador et al, Chapter 27:“Cross-domain Recommender System”, which is a document related to research on domain adaptation in information suggestion, differences in domains are classified into the following four categories.

Item Attribute Level

For example, a comedy movie and a horror movie are in different domains.

Item Type Level

For example, a movie and a TV drama series are in different domains.

Item Level

For example, a movie and a book are in different domains.

System Level

For example, a movie in a movie theater and a movie broadcast on television are in different domains.

The difference in facility shown in FIG. 5 or the like corresponds to the domain of the system level in the above four categories.

In a case where a domain is formally defined, the domain is defined by a simultaneous probability distribution P(X,Y) of a response variable Y and an explanatory variable X, and in a case where Pd1(X,Y)≠Pd2(X,Y), d1 and d2 are different domains.

The simultaneous probability distribution P(X,Y) can be represented by a product of an explanatory variable distribution P(X) and a conditional probability distribution P(Y|X) or a product of a response variable distribution P(Y) and a conditional probability distribution P(Y|X).

P(X,Y)=P(Y|X)P(X)=P(X|Y)P(Y)

Therefore, in a case where one or more of P(X), P(Y), P(Y|X), and P(X|Y) is changed, the domains become different from each other.

Typical Pattern of Domain Shift

Covariate Shift

In a case where the distributions P(X) of the explanatory variables are different, it is called a covariate shift. For example, a case where distributions of user attributes are different between datasets, more specifically, a case where a gender ratio is different, and the like correspond to the covariate shift.

Prior Probability Shift

In a case where the distributions P(Y) of the response variables are different, it is called a prior probability shift. For example, a case where an average browsing rate or an average purchase ratio differs between datasets corresponds to the prior probability shift.

Concept Shift

A case where conditional probability distributions P(Y|X) and P(X|Y) are different is called a concept shift. For example, a probability that a research and development department of a certain company reads data analysis materials is assumed as P(Y|X), and in a case where the probability differs between datasets, this case corresponds to the concept shift.

Research on domain adaptation or domain generalization includes assuming one of the above-mentioned patterns as a main factor and looking at dealing with P(X,Y) changing without specifically considering which pattern is a main factor. In the former case, there are many cases in which a covariate shift is assumed.

Reason for Influence of Domain Shift

A prediction classification model that performs a prediction or classification task makes inferences based on a relationship between the explanatory variable X and the response variable, thereby in a case where P(Y|X) is changed, naturally at least one of the prediction performance or classification performance is decreased. Further, although minimization of at least one of a prediction error or a classification error is performed within learning data in a case where machine learning is performed on the prediction classification model, for example, in a case where the frequency in which the explanatory variable becomes X=X_1 is greater than the frequency in which the explanatory variable becomes X=X_2, that is, in a case where P(X=X_1)>P(X=X_2), since the data of X=X_1 is more than the data of X=X_2, error decrease for X=X_1 is trained in preference to error decrease for X=X_2. Therefore, even in a case where P(X) is changed between the facilities, at least one of the prediction error or the classification error is reduced.

The domain shift can be a problem not only for information suggestion but also for various task models. For example, regarding a model that predicts the retirement risk of an employee, a domain shift may become a problem in a case where a prediction model, which is trained by using data of a certain company, is operated by another company.

Further, in a model that predicts an antibody production amount of a cell, a domain shift may become a problem in a case where a model, which is trained by using data of a certain antibody, is used for another antibody. Further, for a model that classifies the voice of customer, for example, a model that classifies VOC into a product function, a support handling, and others, a domain shift may be a problem in a case where a classification model, which is trained by using data related to a certain product, is used for another product. Further, VOC is an abbreviation for Voice of Customer, which is an English notation of a customer's voice.

Regarding Evaluation Before Introduction of Model

In many cases, a performance evaluation is performed on the model 14 before the trained model 14 is introduced into an actual facility or the like. The performance evaluation is necessary for determining whether or not to introduce the model and for research and development of models or learning methods.

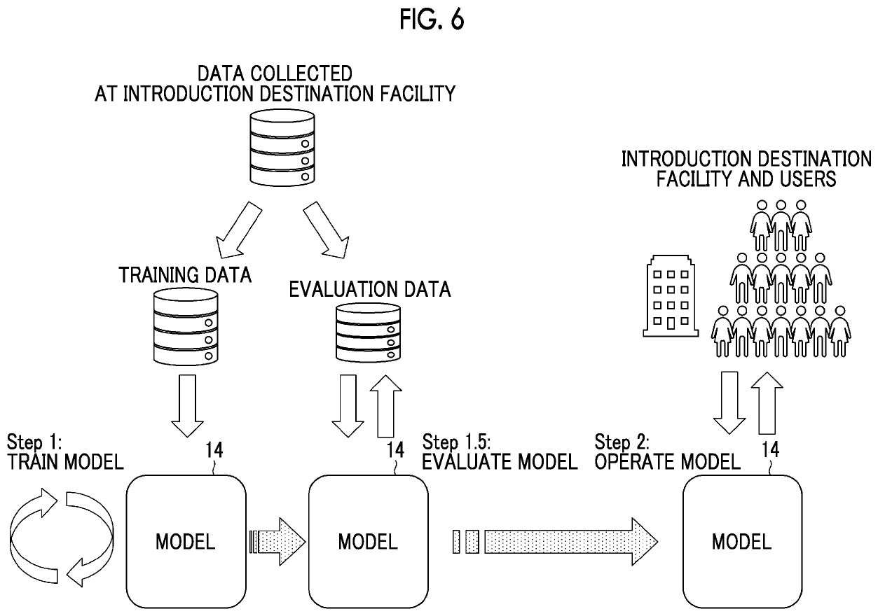

FIG. 6 is an explanatory diagram of an introduction flow of the suggestion system including a step of evaluating the performance of the trained learning model. In FIG. 6, a step of evaluating the performance of the model 14 is added as Step 1.5 between Step 1 of training the model 14 and Step 2 of operating the model 14 described in FIG. 5. Other configurations are the same as in FIG. 5.

As shown in FIG. 6, in a general introduction flow of the suggestion system, the data, which is collected at the introduction destination facility, is often divided into training data and evaluation data. The prediction performance of the model 14 is checked by using the evaluation data, and then the operation of the model 14 is started.

However, in a case of building the model 14 of domain generalization, the training data and the evaluation data need to be different domains. Further, in the domain generalization, it is preferable to use the data of a plurality of domains as the training data, and it is more preferable that there are many domains that can be used for a training.

Regarding Generalization

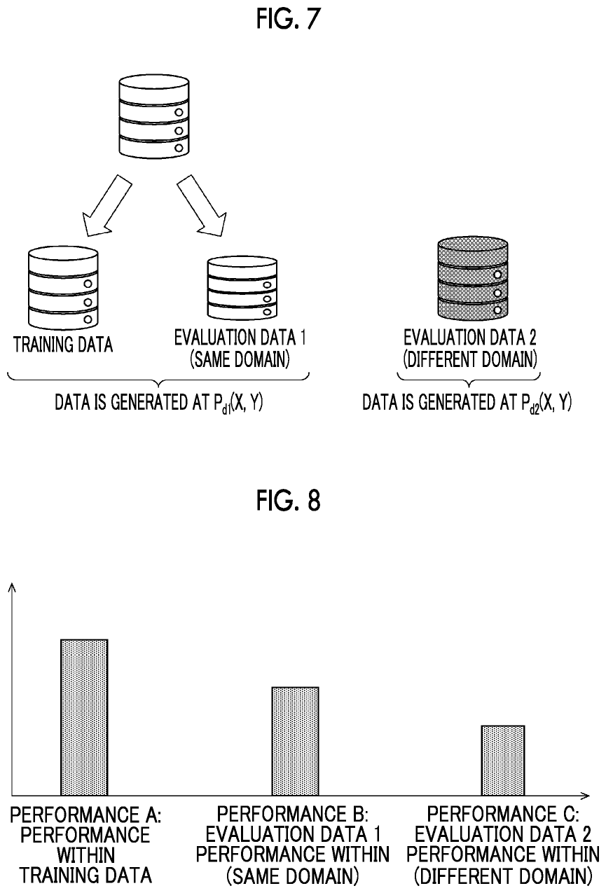

FIG. 7 is an explanatory diagram showing an example of training data and evaluation data used for the machine learning. The dataset obtained from the simultaneous probability distribution Pd1(X,Y) of a certain domain d1 is divided into training data and evaluation data. The evaluation data of the same domain as the training data is referred to as first evaluation data and is referred to as evaluation data 1 in FIG. 7. Further, a dataset, which is obtained from a simultaneous probability distribution Pd2(X,Y) of a domain d2 different from the domain d1, is prepared and is used as the evaluation data. The evaluation data of the different domain with the training data is referred to as second evaluation data and is referred to as evaluation data 2 in FIG. 7.

The model 14 is trained by using the training data of the domain d1, and the performance of the model 14, which is trained by using each of the first evaluation data of the domain d1 and the second evaluation data of the domain d2, is evaluated.

FIG. 8 is a graph schematically showing a difference in performance of a model due to a difference in a dataset. In a case where the performance of the model 14 in the training data is defined as performance A, the performance of the model 14 in the first evaluation data is defined as performance B, and the performance of the model 14 in the second evaluation data is defined as performance C, normally, a relationship is represented such that performance A>performance B>performance C, as shown in FIG. 8.

High generalization performance of the model 14 generally indicates that the performance B is high, or indicates that a difference between the performances A and B is small. That is, the high generalization performance of the model 14 aims at high prediction performance even for untrained data without over-fitting to the training data.

In the context of domain generalization in the present specification, it means that the performance C is high or a difference between the performance B and the performance C is small. In other words, the aim is to achieve high performance consistently even in a domain different from the domain used for the training.

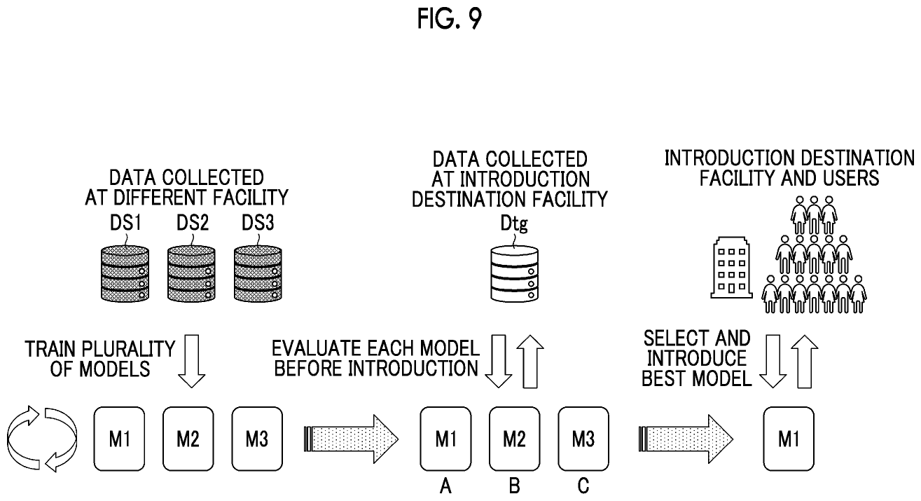

Although the data of the introduction destination facility cannot be used in a case where the training of the model 14 is performed, data that is obtained at the introduction destination facility may be used to evaluate model performance in a case where the data that is collected at the introduction destination facility can be obtained in a case of the introduction. It is conceivable to select the optimum model from among the plurality of candidate models based on the evaluation result and apply the selected model to the introduction destination facility. An example thereof is shown in FIG. 9.

FIG. 9 is an explanatory diagram showing an example of an introduction flow of the suggestion system in a case where a learning domain and an introduction destination domain are different from each other. As shown in FIG. 9, a plurality of models can be trained by using the data collected at a facility different from the introduction destination facility. Here, an example is shown in which training of a model M1, a model M2, and a model M3 is performed by using a dataset DS1, a dataset DS2, and a dataset DS3 collected at different facilities from each other. For example, the model M1 is trained by using the dataset DS1, the model M2 is trained by using the dataset DS2, and the model M3 is trained by using the dataset DS3. The dataset used for the training of each of the model M1, the model M2, and the model M3 may be a combination of a plurality of datasets collected at different facilities. For example, the model M1 may be trained by using a dataset in which the dataset DS1 and the dataset DS2 are mixed.

In this way, after the plurality of models M1, M2, and M3 are trained, the performance of each of the model M1, the model M2, and the model M3 is evaluated by using data Dtg collected at the introduction destination facility. In FIG. 9, the symbols A, B, and C shown below each of the model M1, the model M2, and the model M3 represent the evaluation results of each of the model M1, the model M2, and the model M3. The evaluation A indicates that the prediction performance satisfies an introduction standard. The evaluation B indicates that the performance is inferior to the evaluation A. The evaluation C is a performance inferior to the evaluation B and indicates that the performance is not suitable for introduction.

For example, as shown in FIG. 9, it is assumed that the evaluation result of the model M1 is an evaluation A, the evaluation result of the model M2 is an evaluation B, and the evaluation result of the model M3 is an evaluation C. The model M1 is selected as the optimum model for the introduction destination facility, and the suggestion system 10 to which the model M1 is applied is introduced.

Problems

As described with reference to FIG. 9, even in a case where the data of the introduction destination facility cannot be obtained in a case of the training of the model, in a case where the data that is collected at the introduction destination facility is present in a case of the introduction of the model, the data can be used to evaluate models and the best model can be selected.

However, a model cannot be selected in a case where data of the introduction destination facility is not present in a case of introduction of a model to the introduction destination facility, or in a case where the data of the introduction destination facility cannot be accessed even in a case where data of the introduction destination facility is present in a case of the introduction of the model to the introduction destination facility.

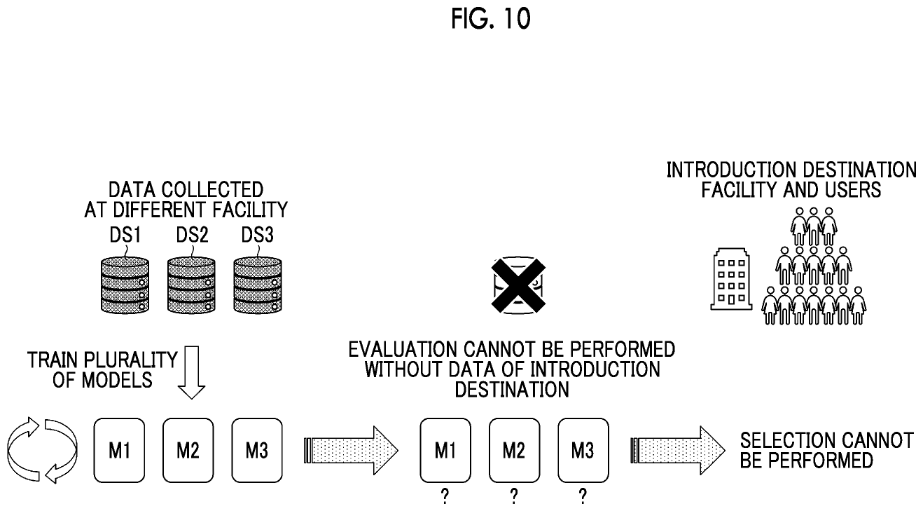

FIG. 10 is an explanatory diagram showing a problem in a case where data of the introduction destination facility is not present. As shown in FIG. 10, in a case where data of the introduction destination facility is not present, each of the model M1, the model M2, and the model M3 cannot be evaluated, and the best model cannot be selected.

As described above, in a case where the data of the introduction destination facility cannot be used even in the evaluation before the introduction of the model, the best model for the introduction destination facility cannot be selected. Even in such a case, it is desired to make a high performance recommendation at the introduction destination facility. Since the learning domain and the introduction destination domain are different, it is a problem to realize a robust recommendation for the domain shift. In the present embodiment, an information processing method and an information processing system capable of presenting a suggested item by utilizing a plurality of models are provided.

Evaluation of Suggested Item List

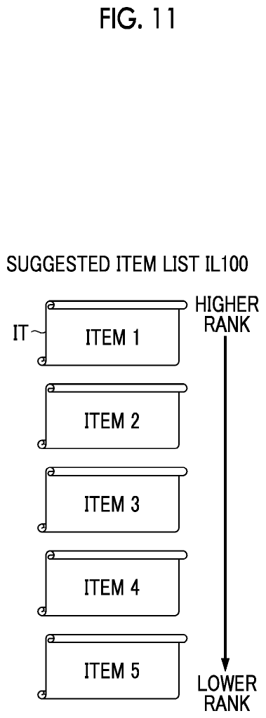

FIG. 11 is a schematic diagram of a typical suggested item list. FIG. 11 illustrates a suggested item list IL100 including an item 1 to an item 5 which are five suggested items.

In the suggested item list IL100 shown in FIG. 11, five suggested items IT are arranged from top to bottom in a predetermined ranking order. The numerical value from 1 to 5 attached to each of the item 1 to the item 5 represents a relative order of the suggested items in the suggested item list IL100.

The suggested item list IL100 is useful to the user in a case where the suggested item desired by the user is included. An example of the suggested item desired by the user includes a suggested item in which the user performs a positive behavior such as browsing.

In a case where the suggested items are arranged from top to bottom, the user tends to view the suggested items in order from the top. The user may not see all the suggested items and only see the suggested item list halfway. In that case, it is desirable that the suggested item desired by the user is relatively higher in rank.

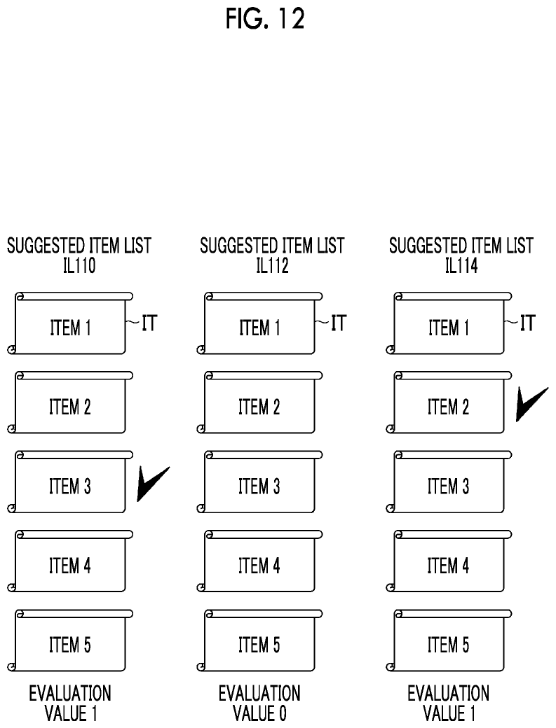

FIG. 12 is a schematic diagram showing an evaluation result in a first example of the suggested item list evaluation. FIG. 12 illustrates a hit rate as an evaluation index of the suggested item list. FIG. 12 illustrates an evaluation value for each of a suggested item list IL110, a suggested item list IL112, and a suggested item list IL114.

Regarding the hit rate, the evaluation value is set to 1 in a case where at least one of the suggested items IT included in each of the suggested item list IL110, the suggested item list IL112, and the suggested item list IL114 is hit. Further, regarding the hit rate, the evaluation value is set to 0 in a case where none of the suggested item IT included in the suggested item list IL110 or the like is hit. The hit of the suggested item IT here means that the user performs a positive behavior with respect to the suggested item IT.

For example, the item 3 in the suggested item list IL110 is illustrated with a mark indicating that it is a hit suggested item IT. Similarly, the item 2 of the suggested item list IL114 is illustrated with a mark indicating that it is a hit suggested item IT.

In a case where the hit rate is applied as the evaluation index of the suggested item list IL110 or the like, the evaluation values of the suggested item list IL110 and the suggested item list IL114 are 1, and the evaluation value of the suggested item list IL110 is 0.

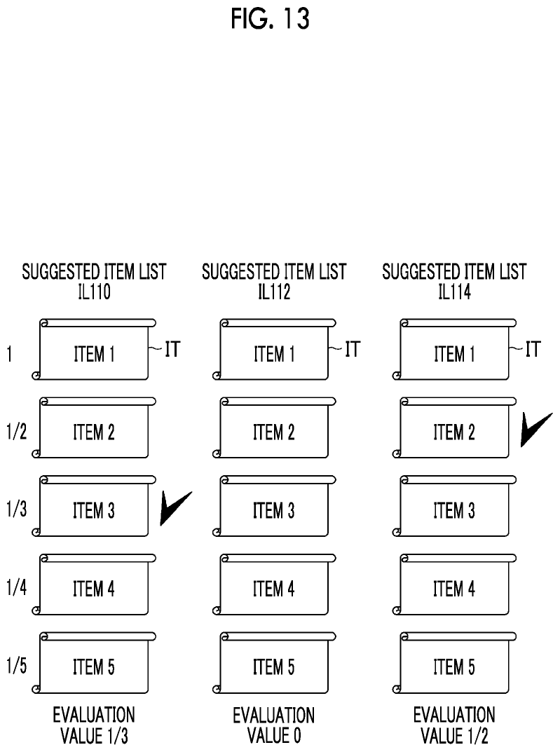

FIG. 13 is a schematic diagram showing an evaluation result in a second example of the suggested item list evaluation. FIG. 13 illustrates a reciprocal rank as an evaluation index of the suggested item list. In the reciprocal rank, each suggested item IT is weighted and evaluated by using a reciprocal of the order as a weight.

FIG. 13 illustrates a case where the item 3 is hit in the suggested item list IL110, none of the item 1 to the item 5 is hit in the suggested item list IL112, and the item 3 is hit in the suggested item list IL114.

In the suggested item list IL110, the item 3 having a weight of ⅓ is hit, and the item 1, the item 2, the item 4, and the item 5 are not hit. Therefore, the evaluation value of the suggested item list IL110 is ⅓.

Further, in the suggested item list IL114, the item 2 having a weight of ½ is hit, and the item 1 and the item 3 to the item 5 are not hit. Therefore, the evaluation value of the suggested item list IL110 is ½.

Further, the evaluation value of the suggested item list IL112, in which none of the item 1 to the item 5 is hit by the user, is 0. A decimal point may be applied to the weight and the evaluation value to which a fraction is applied.

An example of another evaluation index includes a discounted cumulative gain. In the discounted cumulative gain, 1/log(1+order) is applied as the weight. That is, as for the weight of the evaluation index in which the weight is used, a relatively large weight is applied to the item having a higher rank.

Outline of Information Processing Method According to Embodiment

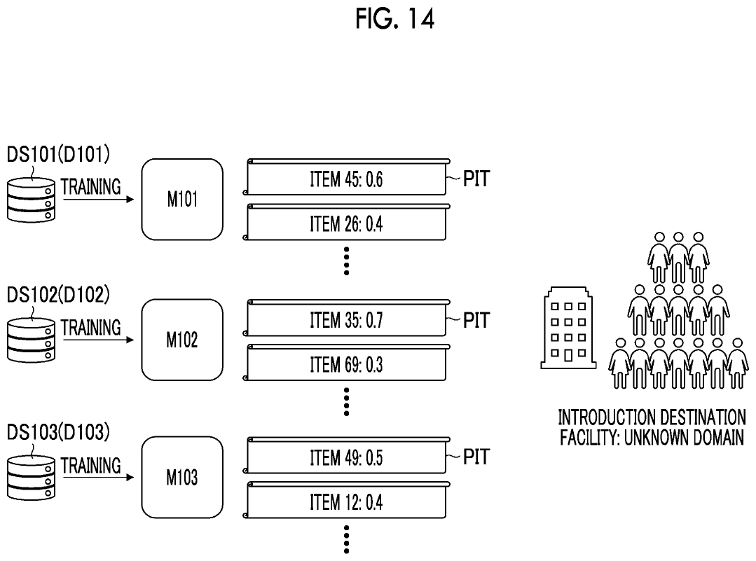

FIG. 14 is an explanatory diagram of an outline of an information processing method according to an embodiment. FIG. 14 illustrates a case where a model M101 that is trained by using a dataset DS101 of a domain D101, a model M102 that is trained by using a dataset DS102 of a domain D102, and a model M103 that is trained by using a dataset DS103 of a domain D104 are present, and a domain of the introduction destination facility is unknown.

The model M101 outputs a plurality of candidate items PIT including an item 45 and an item 26. The plurality of candidate items PIT are arranged in the order of prediction values. As the prediction value of the candidate item PIT, a probability that the user performs a positive behavior such as browsing and purchasing may be applied with respect to the candidate item PIT. In the model M101, the prediction value of the item 45 is 0.6, and the prediction value of the item 26 is 0.4.

The model M102 outputs a plurality of candidate items PIT including an item 35 and an item 36. The prediction value of the item 35 is 0.7, and the prediction value of the item 69 is 0.3.

The model M103 outputs a plurality of candidate items PIT including an item 49 and an item 12. The prediction value of the item 49 is 0.5, and the prediction value of the item 12 is 0.4.

The numerical value assigned to the candidate item PIT shown in FIG. 14 is an identification number of the candidate item PIT common to the candidate items PIT output from the model M101, the model M102, and the model M103. The candidate item PIT that is output from the model M101 can be grasped as the suggested item list output from the model M101.

In a case where a plurality of models are prepared by using a plurality of datasets of various domains, it is assumed that the domain of the introduction destination facility has an attribute similar to any domain of the plurality of models. Here, the domain of the model means the domain of a provision destination of the dataset applied in a case of the training of the model. The fact that the attributes of the domains are close represents a case where the attributes of the domains, which are grasped as the characteristics of the domains, such as the age group, gender, and occupation of users, are the same or the attributes of the domains have commonalities.

A model that is trained by using a dataset of a domain of which an attribute is similar to the domain of the introduction destination facility can perform highly accurate suggestion. However, it is not known which of the plurality of domains has the closest attribute to the domain of the introduction destination facility.

Therefore, it is desired to generate a high performance suggested item list even in a case where any of the plurality of models has similar attributes to the domain of the introduction destination facility. The term “high performance” as used herein means having at least robust performance against the domain shift.

Evaluation of Suggested Item List in which Domain of Introduction Destination Facility is Applied

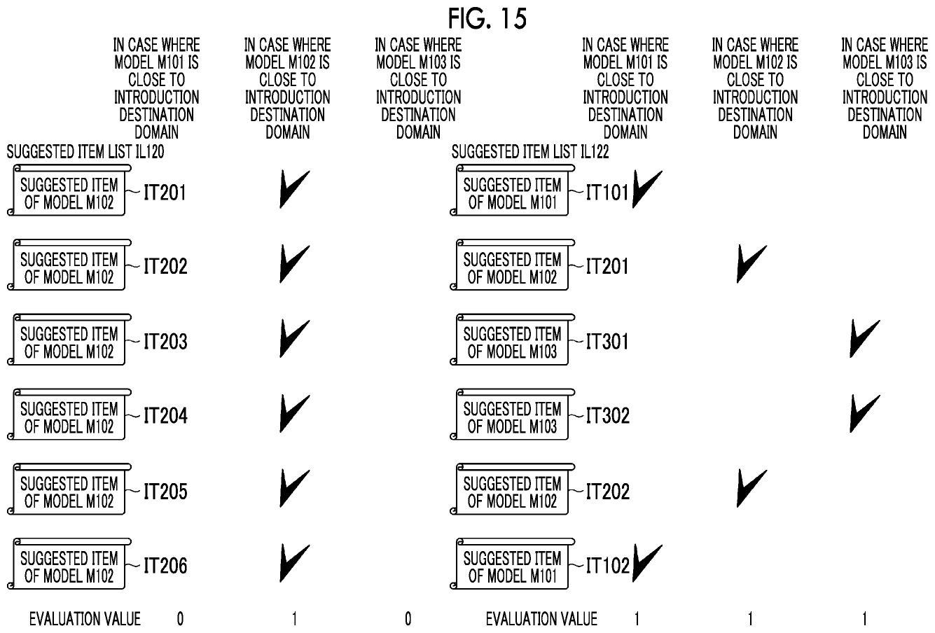

FIG. 15 is a schematic diagram showing a specific example of the suggested item list evaluation. FIG. 15 shows an example in which the hit rate is applied as an evaluation index. The suggested item list IL120 shown in FIG. 15 includes a suggested item IT 201, a suggested item IT 202, a suggested item IT 203, a suggested item IT 204, a suggested item IT 205, and a suggested item IT 206 that are selected from a plurality of candidate items PIT output only from the model M102. The suggested items IT201 to the suggested items IT206 are arranged from the top in the order of prediction values in which the user performs a positive behavior.

In a case where the domain corresponding to the model M101 has the attribute close to that of the domain of the introduction destination facility for the suggested item list IL120, it is predicted that none of the suggested item IT201 to the suggested item IT206 is hit. Accordingly, the evaluation value of the suggested item list IL120 becomes 0. The same applies to the case where the domain corresponding to the model M103 has the attribute close to that of the domain of the introduction destination facility for the suggested item list IL120.

On the other hand, in a case where the domain corresponding to the model M102 has the attribute close to that of the domain of the introduction destination facility for the suggested item list IL120, it is predicted that all items from the suggested item IT201 to the suggested item IT206 are hit. Accordingly, the evaluation value of the suggested item list IL120 becomes 1.

The suggested item list IL122 includes a plurality of suggested items IT selected from the candidate items PIT output from each of the model M101, the model M102, and the model M103. Specifically, the suggested item list IL122 includes the suggested item IT101 and the suggested item IT102 output from the model M101.

Further, the suggested item list IL122 includes the suggested item IT201 and the suggested item IT202 output from the model M102, and the suggested item IT301 and the suggested item IT302 output from the model M103.

In the suggested item list IL122, a plurality of suggested items IT are arranged from the top in the order of the highest ranking suggested item IT101 of the model M101, the highest ranking suggested item IT201 of the model M102, the highest ranking suggested item IT301 of the model M103, the second ranking suggested item IT302 of the model M103, the second ranking suggested item IT202 of the model M102, and the second ranking suggested item IT102 of the model M101.

In a case where the domain corresponding to the model M101 has the attribute close to that of the domain of the introduction destination facility, the evaluation value of the suggested item list IL122 is 1. Even in a case where the domain corresponding to the model M102 has the attribute close to that of the domain of the introduction destination facility, and even in a case where the domain corresponding to the model M103 has the attribute close to that of the domain of the introduction destination facility, the evaluation value of the suggested item list IL122 is 1.

That is, the suggested item list IL120, which includes the suggested items IT biasedly selected only from the candidate item PIT of the model M102, has high performance in a case where the model M102 has the attribute close to that of the domain of the introduction destination but has lower performance in a case where the model M101 or M103 has the attribute close to that of the domain of the introduction destination as compared with a case where the model M102 has the attribute close to that of the domain of the introduction destination.

On the other hand, the suggested item list IL 122, which includes the suggested items IT selected from each of the candidate item PIT of the model M101, the candidate item PIT of the model M102, and the candidate items PIT of the model M103 in a well-balanced manner, has high performance in any of the above cases.

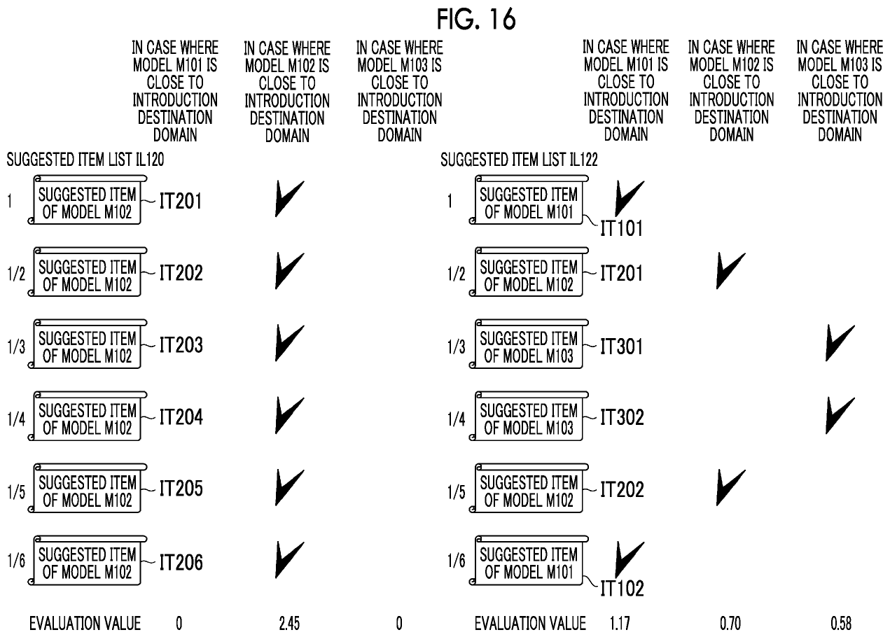

FIG. 16 is a schematic diagram showing another specific example of the suggested item list evaluation. FIG. 16 shows an example in which the reciprocal rank is applied as an evaluation index. The fraction attached to the suggested item IT201 or the like is a weight of the evaluation index for each suggested item IT.

In a case where the domain corresponding to the model M101 has the attribute close to that of the domain of the introduction destination facility, the evaluation value of the suggested item list IL120 is 0. Similarly, even in a case where the domain corresponding to the model M103 has the attribute close to that of the domain of the introduction destination facility, the evaluation value of the suggested item list IL120 is 0. Further, in a case where the domain corresponding to the model M102 has the attribute close to that of the domain of the introduction destination facility, the evaluation value of the suggested item list IL120 is 2.45.

In a case where the domain corresponding to the model M101 has the attribute close to that of the domain of the introduction destination facility, the evaluation value of the suggested item list IL122 is 1.17. In a case where the domain corresponding to the model M102 has the attribute close to that of the domain of the introduction destination facility, the evaluation value of the suggested item list IL122 is 0.70. In a case where the domain corresponding to the model M103 has the attribute close to that of the domain of the introduction destination facility, the evaluation value of the suggested item list IL122 is 0.58.

As hit rate is applied as the evaluation index, for the suggested item list IL120 that includes the suggested items IT biasedly selected from the suggested item IT of any suggestion model, the suggested item list IL122, which includes the suggested items IT in which the suggested items IT of the plurality of suggestion models are selected in a well-balanced manner, has high performance.

Specific Example of Preferable Suggested Item Selection

As a specific example of preferred suggested item selection, it is considered of a suggestion system for a retail store. As the learning data of the suggestion model, a dataset DS11 of a purchase history in a store S1, a dataset DS12 of a purchase history in a store S2, and a dataset DS13 of a purchase history in a store S3 can be used. The purchase history in each store is a user behavior history in each store.

In a case of developing the suggestion system to be introduced in a newly opened store S4, a purchase history dataset in the store S4 which is the introduction destination facility is not present. Further, it is unclear whether an attribute of a domain of the store S4 is close to an attribute of any of the store S1, the store S2, or the store S3.

A model M11, a model M12, and a model M13 are prepared, which are trained by using the dataset DS11, the dataset DS12, and the dataset DS13 in each of the store S1, the store S2, and the store S3. The model M11, the model M12, and the model M13 use a matrix factorization model which is a kind of model-based collaborative filtering. The number of dimensions of the matrix is 100.

The model M11, the model M12, and the model M13 are trained by applying a stochastic gradient descent using a log loss with respect to the prediction of the presence or absence of purchase as an index. Note that, the log loss may be referred to as Logarithmic Loss. Further, the stochastic gradient descent can be referred to as a probabilistic gradient descent method.

Next, the suggested item list IL11, the suggested item list IL12, and the suggested item list IL13 for each of a plurality of users are generated by using the model M11, the model M12, and the model M13. The size of the suggested item list IL11, the suggested item list IL12, and the suggested item list IL13 is set to 6. The size of the suggested item list IL11 or the like means the number of suggested items IT included in the suggested item list IL11 or the like.

The reciprocal rank is applied as an evaluation index of the suggested item list IL so that any one of the model M11, the model M12, or the model M13 has high performance. Specifically, for one-third of all users, the first ranking suggested item IT and the sixth ranking suggested item IT of the suggested item list IL are selected from the suggested items IT of the model M11.

Further, the second ranking suggested item IT and the fifth ranking suggested item IT of the suggested item list IL are selected from the suggested items IT of the model M12, and the third ranking suggested item IT and the fourth ranking suggested item IT are selected from the suggested items IT of the model M13.

Furthermore, for one-third of all users, who are different from the above one-third of users, the first ranking suggested item IT and the sixth ranking suggested item IT of the suggested item list IL are selected from the suggested items IT of the model M12. The second ranking suggested item IT and the fifth ranking suggested item IT of the suggested item list IL are selected from the suggested items IT of the model M13, and the third ranking suggested item IT and the fourth ranking suggested item IT are selected from the suggested items IT of the model M11.

Specifically, for the remaining one-third of users, the first ranking suggested item IT and the sixth ranking suggested item IT of the suggested item list IL are selected from the suggested items IT of the model M13. The second ranking suggested item IT and the fifth ranking suggested item IT of the suggested item list IL are selected from the suggested items IT of the model M11, and the third ranking suggested item IT and the fourth ranking suggested item IT are selected from the suggested items IT of the model M12.

That is, the suggested item IT of the model M11, the suggested item IT of the model M12, and the suggested item IT of the model M13 are candidate items that are candidates for the suggested items IT constituting the suggested item list IL. The suggested item list IL includes a suggested item IT selected from a plurality of candidate items based on a predetermined selection condition.

As a result, even in a case where the domain of the store S4 has the attribute close to that of any of the domains of the model M11, the model M12, and the model M13, the suggested item list IL has similar evaluation values in a plurality of evaluation indices such as hit rate and reciprocal rank and has similar performance. Therefore, the suggestion system that outputs the suggested item list IL described above can realize a robust suggestion against the domain shift.

Configuration Example of Information Processing System

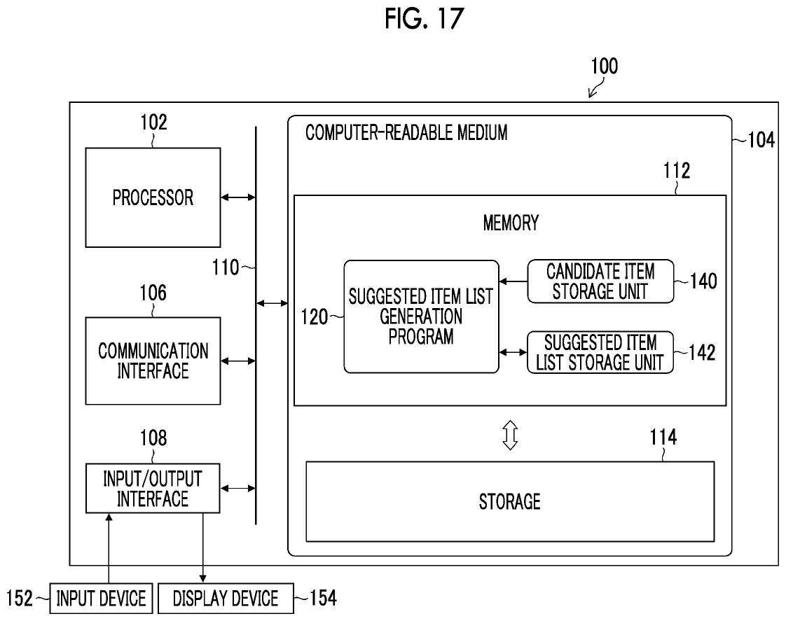

Next, a configuration example of an information processing system applied to a suggestion system having robust performance against the domain shift will be described. FIG. 17 is a block diagram schematically showing an example of a hardware configuration of an information processing system according to the embodiment.

The information processing apparatus 100 can be realized by using hardware and software of a computer. The physical form of the information processing apparatus 100 is not particularly limited, and may be a server computer, a workstation, a personal computer, a tablet terminal, or the like. Although an example of realizing a processing function of the information processing apparatus 100 using one computer will be described here, the processing function of the information processing apparatus 100 may be realized by a computer system configured by using a plurality of computers.

The information processing apparatus 100 includes a processor 102, a computer-readable medium 104 that is a non-transitory tangible object, a communication interface 106, an input/output interface 108, and a bus 110.

The processor 102 includes a central processing unit (CPU). The processor 102 may include a graphics processing unit (GPU). The processor 102 is connected to the computer-readable medium 104, the communication interface 106, and the input/output interface 108 via the bus 110.

The processor 102 reads out various programs, data, and the like stored in the computer-readable medium 104 and executes various processes. The term program includes the concept of a program module and includes commands conforming to the program.

The computer-readable medium 104 is, for example, a storage device including a memory 112 which is a main memory and a storage 114 which is an auxiliary storage device. The storage 114 is configured by using, for example, a hard disk device, a solid state drive device, an optical disk, a photomagnetic disk, a semiconductor memory, or the like. The storage 114 may be configured by using an appropriate combination of the above-described devices. Various programs, data, and the like are stored in the storage 114.

The hard disk device may be referred to as an HDD by using an abbreviation of Hard Disk Drive in English. The solid state drive device may be referred to as an SSD using the English notation Solid State Drive.

The memory 112 includes an area used as a work area of the processor 102 and an area for temporarily storing a program read from the storage 114 and various types of data. By loading the program that is stored in the storage 114 into the memory 112 and executing commands of the program by the processor 102, the processor 102 functions as a unit for performing various processes defined by the program.

The memory 112 stores various programs such as a suggested item list generation program 120 executed by the processor 102, various types of data, and the like. The suggested item list generation program 120 may include a plurality of programs.

That is, the suggested item list generation program 120 acquires a plurality of candidate items from the plurality of suggestion models and selects a number of candidate items corresponding to a predetermined size of the suggested item list from the plurality of candidate items as the suggested items. The suggested item list generation program 120 may apply a predetermined selection condition in a case of selecting a suggested item from the plurality of candidate items.

Further, the suggested item list generation program 120 applies a predetermined alignment condition with respect to the suggested items, arranges the suggested items, and generates a suggested item list presented to the user.

In a case of acquiring the candidate items, the candidate items may be acquired from each of the plurality of models stored in the memory 112, or the candidate items may be acquired from each of the plurality of models stored in an external device of the information processing apparatus 100.

The memory 112 may store a learning program that performs a training of the plurality of models. The processor 102 may execute the learning program to perform the training of the plurality of models. The memory 112 may store the learning data used in a case of the training of the plurality of models.

The memory 112 includes a candidate item storage unit 140. The candidate item storage unit 140 stores the candidate items used by the suggested item list generation program 120.

The memory 112 includes a suggested item list storage unit 142. The suggested item list storage unit 142 stores a suggested item list generated by the processor 102 executing the suggested item list generation program 120.

The communication interface 106 performs a communication process with an external device by wire or wirelessly and exchanges information with the external device. The information processing apparatus 100 is connected to a communication line via the communication interface 106.

The communication line may be a local area network, a wide area network, or a combination thereof. It should be noted that the illustration of the communication line is omitted. The communication interface 106 can play a role of a data acquisition unit that receives input of various data such as the original dataset.

The information processing apparatus 100 includes an input device 152 and a display device 154. The input device 152 and the display device 154 are connected to the bus 110 via the input/output interface 108. For example, a keyboard, a mouse, a multi-touch panel, other pointing devices, a voice input device, or the like can be applied to the input device 152. The input device 152 may be an appropriate combination of the keyboard and the like described above.

For example, a liquid crystal display, an organic EL display, a projector, or the like is applied to the display device 154. The display device 154 may be an appropriate combination of the above-described liquid crystal display or the like. The input device 152 and the display device 154 may be integrally configured as in the touch panel, or the information processing apparatus 100, the input device 152, and the display device 154 may be integrally configured as in the touch panel type tablet terminal. The organic EL display may be referred to as OEL, which is an abbreviation for organic electro-luminescence. Further, EL of an organic EL display is an abbreviation for Electro-Luminescence.

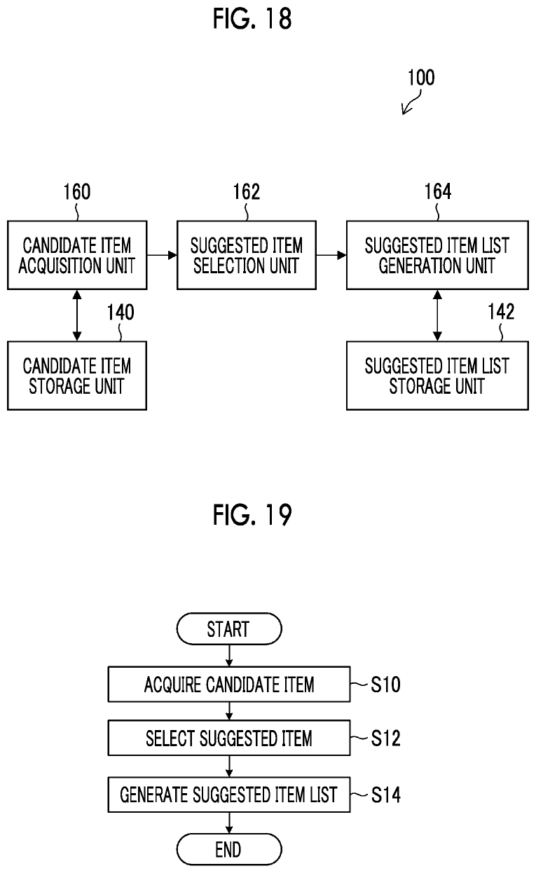

FIG. 18 is a functional block diagram showing a functional configuration of the information processing system according to the embodiment. The information processing apparatus 100 includes a candidate item acquisition unit 160, a suggested item selection unit 162, and a suggested item list generation unit 164.

The candidate item acquisition unit 160 acquires a plurality of candidate items from each of the plurality of suggestion models. The candidate item acquisition unit 160 stores the plurality of candidate items in the candidate item storage unit 140.

The suggested item selection unit 162 selects, as the suggested item, a number of candidate items corresponding to the size of the suggested item list from among the plurality of candidate items acquired by the candidate item acquisition unit 160.

The suggested item list generation unit 164 generates the suggested item list by using the plurality of suggested items selected by the suggested item selection unit 162. The suggested item list generation unit 164 stores the suggested item list in the suggested item list storage unit 142.

Procedure of Information Processing Method

FIG. 19 is a flowchart showing a procedure of the information processing method according to the embodiment. In a candidate item acquisition step S10, the candidate item acquisition unit 160 shown in FIG. 18 acquires the plurality of candidate items. In the candidate item acquisition step S10, the candidate item acquisition unit 160 stores the acquired plurality of candidate items in the candidate item storage unit 140. After the candidate item acquisition step S10, the process proceeds to a suggested item selection step S12.

In the candidate item acquisition step S10, a prediction value representing a probability that the user performs a positive behavior may be calculated for each candidate item, and a list of a plurality of candidate items arranged by descending order of prediction values may be acquired for each model.

In the suggested item selection step S12, the suggested item selection unit 162 selects a candidate item to be a suggested item from among the plurality of candidate items acquired in the candidate item acquisition step S10. After the suggested item selection step S12, the process proceeds to a suggested item list generation step S14.

In the suggested item list generation step S14, the suggested item list generation unit 164 generates a suggested item list by using the plurality of suggested items selected in the suggested item selection step S12. In the suggested item list generation step S14, the suggested item list generation unit 164 stores the suggested item list in the suggested item list storage unit 142. After the suggested item list generation step S14, the information processing apparatus 100 ends the procedure of the information processing method.

In the suggested item list generation step S14, according to the candidate list evaluation step of evaluating the plurality of candidate lists including the selected suggested item and the evaluation result of the candidate list, a suggested item list selection step of selecting a suggested item list from the plurality of candidate lists may be executed.

Suggested Item List Generation Method According to First Embodiment

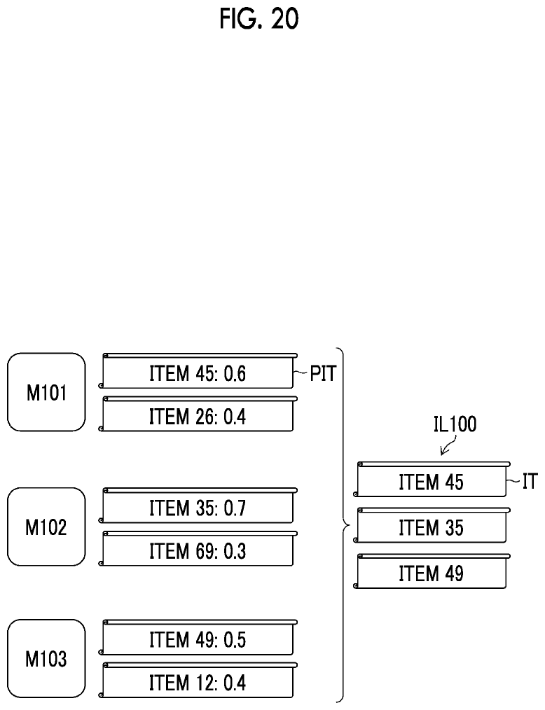

FIG. 20 is a schematic diagram showing a suggested item list generation method according to a first embodiment. Hereinafter, a suggested item list method of generating a suggested item list by applying the above-described information processing method and information processing system will be described in detail.

In the suggested item list generation method according to the first embodiment, first, the processor 102 shown in FIG. 17 executes a suggested item list generation program 120 to acquire candidate items PIT from each of the model M101, the model M102, and the model M103. FIG. 20 shows an example in which two candidate items PIT are acquired from each of the model M101, the model M102, and the model M103.

The processor 102 acquires one or more candidate items PIT from each of the model M101, the model M102, and the model M103, and as a result, acquires a plurality of candidate items PIT. The acquired plurality of candidate items PIT are stored in the candidate item storage unit 140.

Next, the processor 102 generates a list in which the acquired plurality of candidate items PIT for each of the model M101, the model M102, and the model M103 are arranged in the order of the prediction values of the suggested items for each model. The processor 102 may use the prediction value that is calculated in advance or may calculate the prediction value.

Here, as the prediction value, the probability that the user behaves positively for each suggested item, such as browsing and purchasing, can be applied. In the example shown in FIG. 20, for the model M101, the item 45 having the prediction value of 0.6 and the item 26 having the prediction value of 0.4 are arranged in descending order of the prediction values from the top.

Similarly, for the model M102, the item 35 having the prediction value of 0.7 and the item 69 having the prediction value of 0.3 are arranged in descending order of the prediction values from the top. For the model M103, the item 45 having the prediction value of 0.5 and the item 12 having the prediction value of 0.4 are arranged in descending order of the prediction values from the top.

The numerical values attached to the candidate item PIT and the suggested item IT are identification numbers. The item 26 illustrated as the candidate item PIT of the model M101 is present as a candidate item having a lower prediction value in each of the model M102 and the model M103. The same applies to the item 69 and the item 12.

Next, the processor 102 selects the highest ranking candidate item PIT from each of the model M101, the model M102, and the model M103 as the suggested item IT, and generates the suggested item list IL100 having robust performance against the domain shift. In the example shown in FIG. 20, the suggested item list IL100 including the item 45, the item 35, and the item 49 is exemplified as the suggested item IT.

The suggested item list generation program 120, which is applied to the first embodiment, includes a prediction value acquisition program that acquires prediction values of candidate items for each model. Further, the suggested item list generation program 120 includes a list generation program that generates a list arranged in the order of prediction values of candidate items for each model. An item selection program that selects higher ranking candidate items from each list. It should be noted that the acquisition of information may include the concept of generating information.

Suggested Item List Generation Method According to Second Embodiment

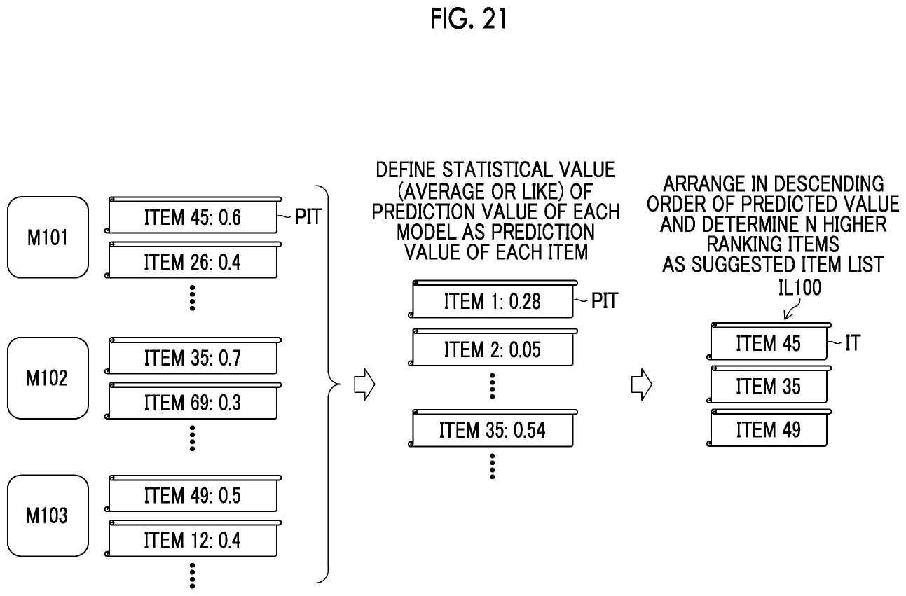

FIG. 21 is a schematic diagram showing a suggested item list generation method according to a second embodiment. In the suggested item list generation method according to the second embodiment, the processor 102 in FIG. 17 calculates a statistical value of a prediction value for each candidate item PIT, and the calculated statistical value is used as the prediction value of each candidate item PIT. The processor 102 selects, from the plurality of candidate items PIT, the number of candidate items PIT to be the suggested item IT according to the size of the suggested item list in descending order of the statistical values of the prediction values for each candidate item PIT.

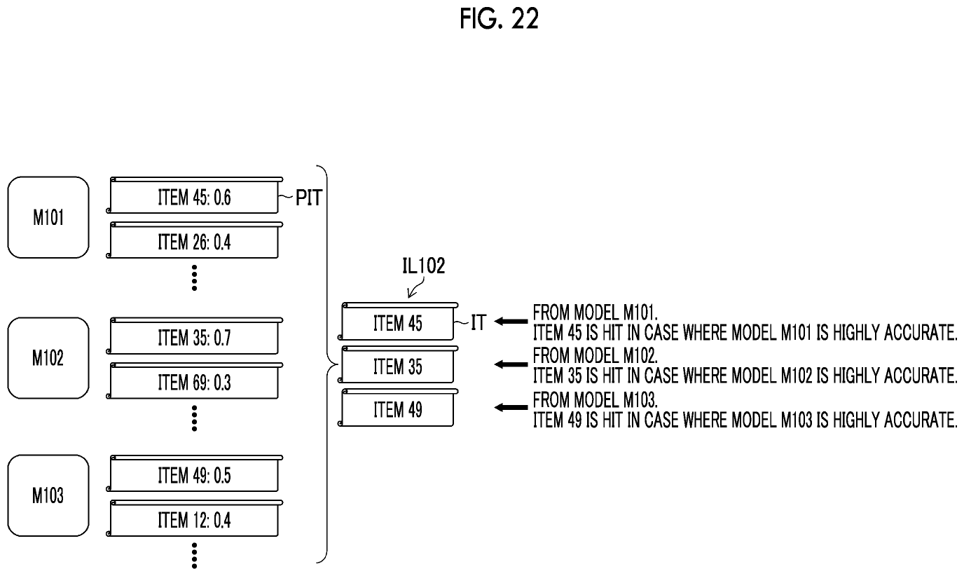

It is assumed that any one of the model M101, the model M102, and the model M103 shown in FIG. 21 has high accuracy. The high accuracy of the model means that the candidate item with the higher rank of prediction is actually browsed by the user. An example of a candidate item with the higher rank of prediction includes a candidate item having a relatively large prediction value. The same applies to the other embodiments described with reference to FIG. 22 and the like.

For example, it is considered a case where 100 candidate items having an item identification number of 1 to 100 are acquired for each of the model M101, the model M102, and the model M103. The processor 102 calculates a statistical value of a prediction value of each candidate item for each model. As the statistical value, a value that is calculated by using any statistical index such as an average value, a maximum value, and a median value may be applied. An arithmetic average value may be applied to the average value. FIG. 21 shows a case where an average value of prediction values of each candidate item for each model is calculated.

For example, 0.28 is calculated as an average value of the prediction value of the item 1 of the model M101, the prediction value of the item 1 of the model M102, and the prediction value of the item 1 of the model M103. Similarly, 0.05 is calculated as an average value of the prediction value of the item 2 of the model M101, the prediction value of the item 2 of the model M102, and the prediction value of the item 2 of the model M103. In this way, the average value of the prediction values is calculated for all the candidate items PIT from the item 1 to the item 100, and the calculated average value of the prediction values is used as the prediction value of each candidate item.

Next, the processor 102 arranges the item 1 to the item 100 from the top in descending order of the prediction values to which the average value is applied, and selects the number of candidate items PIT corresponding to the size of the suggested item list IL100 as the suggested items IT in order of the highest ranking candidate item PIT. FIG. 21 illustrates the suggested item list IL100 to which the item 45, the item 35, and the item 49 are applied to the suggested items IT.

The suggested item list generation program 120, which is applied to the second embodiment, includes a statistical value acquisition program that acquires the statistical value of the prediction values for each item, in addition to the prediction value acquisition program, the list generation program, and the item selection program.

Suggested Item List Generation Method According to Third Embodiment

FIG. 22 is a schematic diagram showing a suggested item list generation method according to a third embodiment. In the suggested item list generation method according to the third embodiment, the processor 102 in FIG. 17 acquires a list in which the candidate items PIT for each model are arranged in descending order of prediction values, and selects the candidate items PIT from the highest rank to k-th rank of the list of each model as the suggested items IT. The size of the suggested item list IL102 is k×the number of models. In other words, the processor 102 selects the number of candidate items PIT obtained by dividing the number corresponding to the size of the suggested item list IL102 by the number of models, as the suggested items IT. Note that, k is a positive integer of 2 or more.

In FIG. 22, an example is shown in which the item 45 having the highest ranking prediction value in the model M101, the item 35 having the highest ranking prediction value in the model M102, and the item 49 having the highest ranking prediction value in the model M103 are selected as the suggested items IT in the suggested item list IL102.

For the suggested item list IL102 shown in FIG. 22, the item 45 is hit in a case where the model M101 is highly accurate. Further, for the suggested item list IL102, the item 35 is hit in a case where the model M102 is highly accurate, and the item 49 is hit in a case where the model M103 is highly accurate.

The suggested item list generation program 120, which is applied to the third embodiment, includes the prediction value acquisition program, the list generation program, and the item selection program, as in the first embodiment.

Suggested Item List Generation Method According to Fourth Embodiment

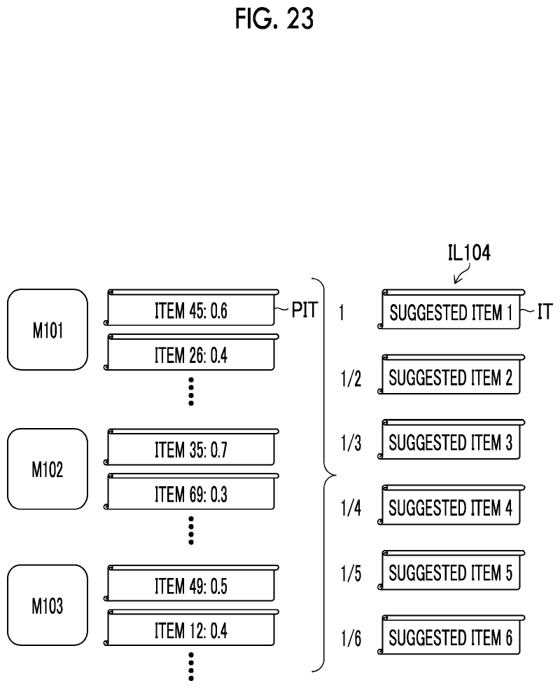

FIG. 23 is a schematic diagram showing a suggested item list generation method according to a fourth embodiment. In the suggested item list generation method according to the fourth embodiment, the processor 102 in FIG. 17 acquires a list in which candidate items for each model are arranged in descending order of prediction values.

In a case where the size of the suggested item list IL104 is larger than the number of models, the weight according to the order of the suggested items IT in the suggested item list IL104 is considered, and the suggested items IT are arranged in a well-balanced manner.

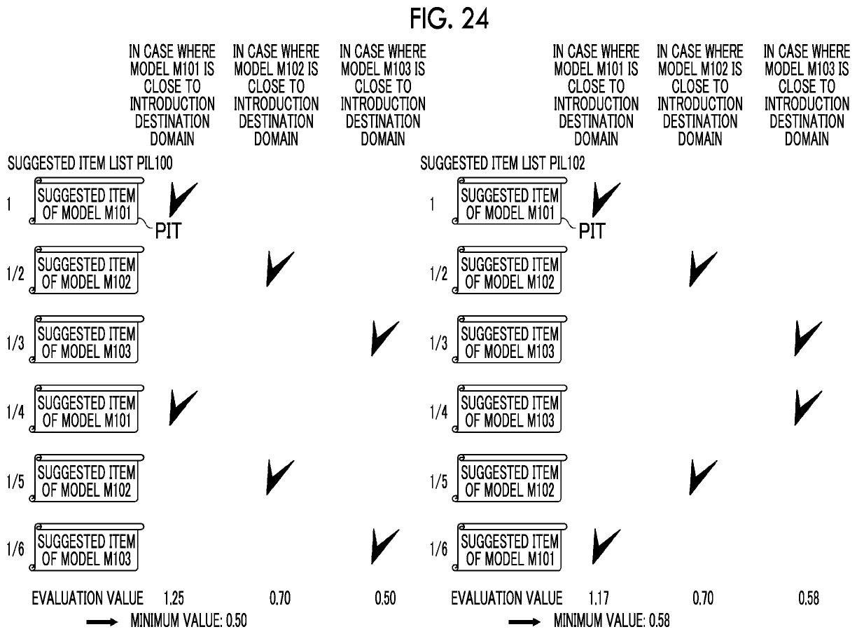

The processor 102 applies the above-described procedure for generating the suggested item list IL 104 to generate a plurality of candidate lists to be candidates for the suggested item list IL 104. The processor 102 calculates, for each of the plurality of candidate lists, an evaluation value that is changed according to compatibility between the domain of the introduction destination facility and the domain corresponding to each model. The candidate list is illustrated as a candidate list PIL100 or the like in FIG. 24.

Here, the compatibility between the domain of the introduction destination facility and the domain corresponding to each model can be grasped as the closeness of attributes between the domain of the introduction destination facility and the domain corresponding to each model. For example, in a case where a similarity degree between the domain of the introduction destination facility and the domain corresponding to each model is relatively large, the compatibility may be high and the attributes may be close to each other. The processor 102 compares the minimum value of the evaluation values for each candidate list and determines the candidate list, in which the minimum value of the evaluation values is the largest, as the suggested item list IL104.

The suggested item list generation program 120, which is applied to the fourth embodiment, includes the prediction value acquisition program, the list generation program, and the item selection program, applied to the fourth embodiment.

Further, the suggested item list generation program 120 includes a candidate list generation program that generates a plurality of candidate lists to be candidates for the suggested item list IL104, and an evaluation value calculation program that calculates the evaluation value.

Suggested Item List Generation Method According to Fifth Embodiment

FIG. 24 is a schematic diagram showing a suggested item list generation method according to a fifth embodiment. As a suggested item list generation method according to the fifth embodiment, a specific example of an evaluation of the candidate list in the suggested item list generation method according to the fourth embodiment will be shown.

The processor 102 in FIG. 17 defines a hypothetical user behavior with respect to the suggested item list according to the model, among the plurality of models, of which the attribute is close to that of the domain of the introduction destination facility. That is, the user behavior is deterministically simulated assuming that a user having a closeness of attributes of the domain performs a positive behavior such as browsing with a 100% probability.

The processor 102 generates the plurality of candidate lists, in which the arrangement order of the suggested items acquired from the plurality of models is changed, and calculates an evaluation value of a predefined evaluation index for each of a plurality of hypothetical user behaviors for each of the plurality of candidate lists. FIG. 24 shows the candidate list PIL100 and a candidate list PIL102 as a plurality of candidate lists.

FIG. 24 schematically shows an example of calculating the evaluation value of the candidate list PIL100 in a case where each of the model M101, the model M102, and the model M103 in FIG. 23 has attributes close to that of the domain of the introduction destination facility.

In the candidate list PIL100, six suggested items IT are arranged in order of a first ranking item of the model M101, a first ranking item of the model M102, a first ranking item of the model M103, a second ranking item of the model M101, a second ranking item of the model M102, and a second ranking item of the model M103.

Further, in the candidate list PIL102, six suggested items IT are arranged in order of a first ranking item of the model M101, a first ranking item of the model M102, a first ranking item of the model M103, a second ranking item of the model M103, a second ranking item of the model M102, and a second ranking item of the model M101.

In FIG. 24, the reciprocal rank is exemplified as the evaluation index of the candidate list PIL100 and the candidate list PIL102. For the candidate list PIL100, the evaluation value in a case where the model M101 has the attribute close to that of the domain of the introduction destination facility is calculated as 1+(¼)=1.25. Similarly, the evaluation value in the case where the model M102 has the attribute close to that of the domain of the introduction destination facility is calculated as 0.70, and the evaluation value in the case where the model M103 has the attribute close to that of the domain of the introduction destination facility is calculated as 0.50. The minimum value of the evaluation values of the candidate list PIL100 is 0.50.

Further, for the candidate list PIL102, the evaluation value in a case where the model M101 has the attribute close to that of the domain of the introduction destination facility is 1.17. The evaluation value in a case where the model M102 has the attribute close to that of the domain of the introduction destination facility is 0.70. The evaluation value in a case where the model M103 has the attribute close to that of the domain of the introduction destination facility is 0.58. The minimum value of the evaluation values of the candidate list PIL100 is 0.58.

In a case of comparing the minimum value 0.50 of the evaluation values of the candidate list PIL100 and the minimum value 0.58 of the evaluation values of the candidate list PIL102, the evaluation value 0.58 of the candidate list PIL102 is larger, thereby the candidate list PIL102 is the best among the plurality of candidate lists and is used as the suggested item list IL.

The method of arranging the best suggested items in the candidate list can be defined according to the size of the candidate list, the number of models, and the evaluation index. The evaluation value of the candidate list may be calculated for any one or more users, and may not be calculated for each of the plurality of users.

The suggested item list generation program 120, which is applied to the fifth embodiment, includes a candidate list determination program that determines a candidate list in which the minimum value of the evaluation values for each evaluation condition is the largest, as the evaluation value calculation program.

Suggested Item List Generation Method According to Sixth Embodiment

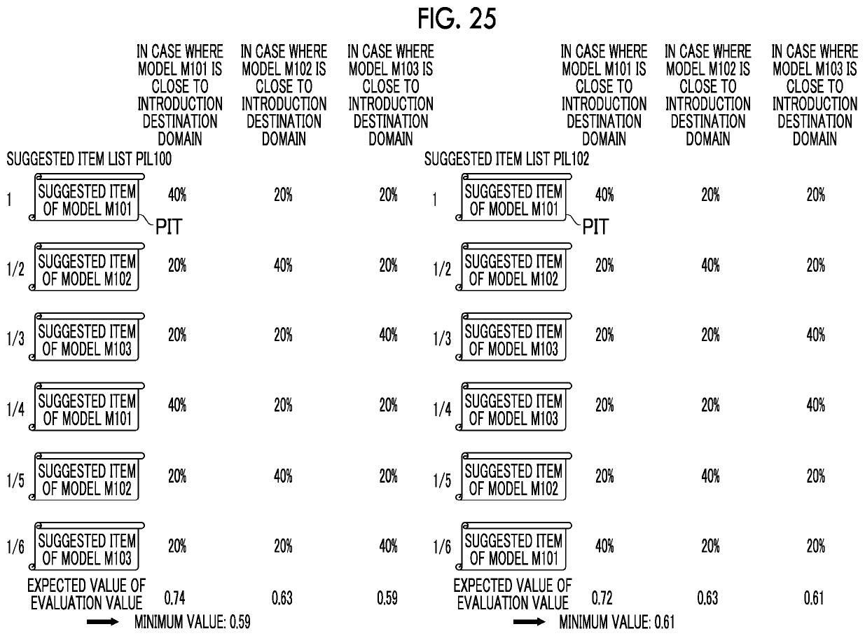

FIG. 25 is a schematic diagram showing a suggested item list generation method according to a sixth embodiment. As a suggested item list generation method according to the sixth embodiment, another specific example of an evaluation of the candidate list in the suggested item list generation method according to the fourth embodiment will be shown.

In FIG. 25, the reciprocal rank is exemplified as the evaluation index of the candidate list PIL100 and the candidate list PIL102. In the sixth embodiment, as a hypothetical user behavior on the suggested item list, it is considered a probabilistic hypothetical case in which a user having a closeness of attributes of the domain performs a positive behavior such as browsing with a probability of 40%, and a user having a distance of attributes of the domain performs a positive behavior such as browsing with a probability of 20%.

For the candidate list PIL100, the evaluation value in a case where the model M101 has the attribute close to that of the domain of the introduction destination facility is calculated as 1×0.4+(½)×0.2+(⅓)×0.2+(¼)×0.4+(⅕)×0.2+(⅙)×0.2=0.74.

Similarly, the evaluation value in the case where the model M102 has the attribute close to that of the domain of the introduction destination facility is calculated as 0.63, and the evaluation value in the case where the model M103 has the attribute close to that of the domain of the introduction destination facility is calculated as 0.59. The minimum value of the evaluation values of the candidate list PIL100 is 0.59.

Further, for the candidate list PIL102, the evaluation value in the case where the model M101 has the attribute close to that of the domain of the introduction destination facility is calculated as 0.72, the evaluation value in the case where the model M102 has the attribute close to that of the domain of the introduction destination facility is calculated as 0.63, and the evaluation value in the case where the model M103 has the attribute close to that of the domain of the introduction destination facility is calculated as 0.61. The minimum value of the evaluation values of the candidate list PIL102 is 0.61. The candidate list PIL 102 is used as the suggested item list IL.

Suggested Item List Generation Method According to Seventh Embodiment

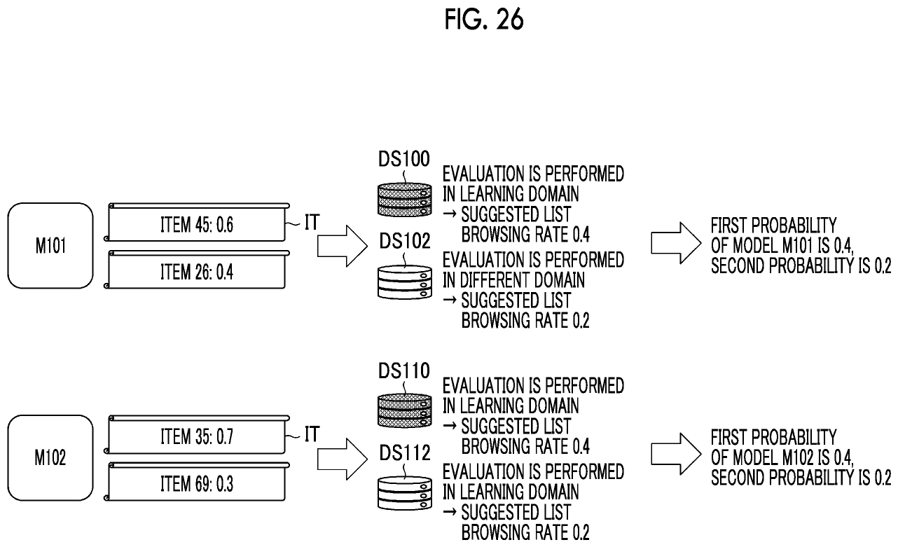

FIG. 26 is a schematic diagram showing a suggested item list generation method according to a seventh embodiment. As a suggested item list generation method according to the seventh embodiment, an example of a method of estimating the probability of a user behavior in the suggested item list generation method according to the sixth embodiment will be shown.

A probability that a user having a closeness of attributes of the domain performs a positive behavior is defined as a first probability, and a probability that a user having a distance of attributes of the domain performs an indefinite behavior is defined as a second probability. For the model M101, by using a dataset DS100 of a first domain that is applied to a training, a list in which items are arranged in order of the prediction values of model M101 is evaluated, and a browsing rate is derived. For example, the browsing rate is 0.4.

Further, by using a dataset DS102 of a second domain that is applied to a training and different from the first domain, a list in which items are arranged in order of the prediction values of model M101 is evaluated, and a browsing rate is derived. For example, the browsing rate is 0.2.

As the first probability of the model M101, the browsing rate of the list in which the items are arranged in the order of the prediction values of the model M101, which uses the dataset DS100 of the domain applied to the training, is applied.

Further, as the second probability of the model M101, the browsing rate of the list in which the items are arranged in the order of the prediction values of the model M101, which uses the dataset DS102 of the second domain that is applied to the training and different from the first domain, is applied.

Similarly, as the first probability of the model M102, the browsing rate 0.4 of the list in which the items are arranged in the order of the prediction values of the model M102, which uses a dataset DS110 of the first domain applied to the training, is applied.

Further, as the second probability of the model M102, the browsing rate 0.2 of the list in which the items are arranged in the order of the prediction values of the model M102, which uses a dataset DS112 of the second domain that is applied to the training and different from the first domain, is applied. Similarly, for other models such as the model M103 shown in FIG. 17, the first probability and the second probability can be defined by using the browsing rate.

FIG. 26 shows an example in which the first probabilities of the model M101 and the model M102 are the same, but the first probabilities of the model M101 and the model M102 may be different. The same applies to the second probability.

For example, the second probability may be calculated as described above, and the arithmetic average value of a browsing rate derived by using the dataset of the first domain applied to the training and a browsing rate derived by using the dataset of the second domain that is applied to the training and different from the first domain, may be defined as the first probability.

The above described derivation of the first probability is based on the idea that a browsing rate of a domain having the attribute close to that of the domain of the introduction destination facility is not the same as a browsing rate of the domain of the introduction destination facility, but places between the browsing rate of the domain of the introduction destination facility and a browsing rate of the domain having the attribute distance from that of the domain of the introduction destination facility.

Suggested Item List Generation Method According to Eighth Embodiment

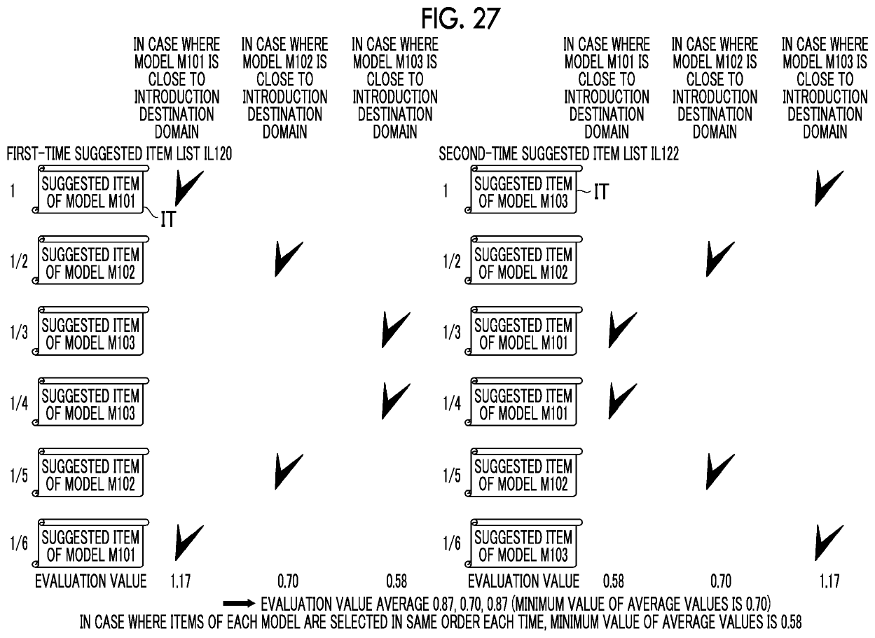

FIG. 27 is a schematic diagram showing a suggested item list generation method according to an eighth embodiment. In an operation of the suggestion system, there may be an opportunity to provide suggestion information to the same user a plurality of times. In the suggested item list generation method according to the eighth embodiment, an arrangement order of the suggested items is changed each time the suggested item list for the same user is generated. Accordingly, on average, suggestion information of constant quality or higher can be provided to one user. It should be noted that a change of the arrangement order of the suggested items for each generation of the suggested item list is an example of a change of the arrangement order of the suggested items for each presentation.

FIG. 27 illustrates a first-time suggested item list IL120 and a second-time suggested item list IL122 for the same user. Further, FIG. 27 shows an evaluation value of each of the first-time suggested item list IL120 and the second-time evaluation item list IL122. A reciprocal rank is applied to the evaluation index.

The same arrangement order as the candidate item PIT in the candidate list PIL 102 shown in FIG. 24 is applied to the evaluation value of the first suggested item list IL120, and six suggested items IT are arranged. The evaluation value of the suggested item list IL120 is the same as the evaluation value of the candidate list PIL102 shown in FIG. 24, and description thereof will be omitted here.

In the second-time item candidate list IL122, the arrangement order of a first ranking item of the model M103, a first ranking item of the model M102, a first ranking item of the model M101, a second ranking item of the model M101, a second ranking item of the model M102, and a second ranking item of the model M103, is applied.

For the suggested item list IL122, the evaluation value in a case where the model M101 has the attribute close to that of the domain of the introduction destination facility is 0.58. The evaluation value in a case where the model M102 has the attribute close to that of the domain of the introduction destination facility is 0.70. The evaluation value in a case where the model M103 has the attribute close to that of the domain of the introduction destination facility is 1.17.

An average value of the evaluation value in a case where the models M101 of the suggested item list IL120 and the suggested item list IL122 have attributes close to that of the domain of the introduction destination facility is (1.17+0.58)/2=0.87. The average value of the evaluation values in a case where the model M102 has the attribute close to that of the domain of the introduction destination facility is 0.70, and the average value of the evaluation values in the case where the model M103 has the attribute close to that of the domain of the introduction destination facility is 0.87. The minimum value of the average values of the evaluation values of the suggested item list IL120 and the suggested item list IL122 is 0.70.

On the other hand, in a case where the suggested item list IL120 or the suggested item list IL122 is provided to the same user a plurality of times, the minimum value of the average values of the evaluation values is 0.58. Therefore, for an evaluation condition of which model domain has the attribute close to that of the introduction destination facility, the suggested item list generation method according to the eighth embodiment can realize the maximization of the minimum value of the average values of the evaluation values for each evaluation condition.

Suggested Item List Generation Method According to Ninth Embodiment

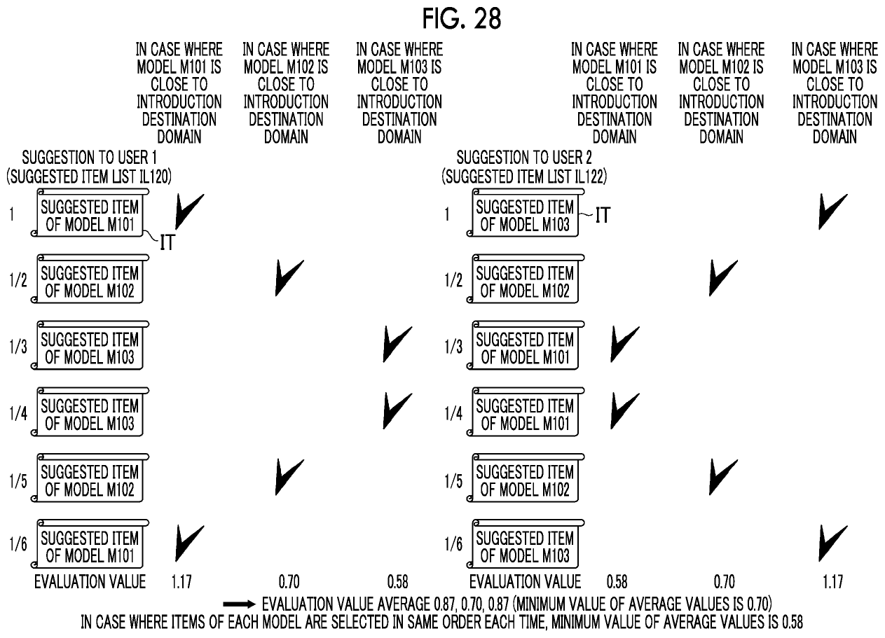

FIG. 28 is a schematic diagram showing a suggested item list generation method according to a ninth embodiment. In the suggested item list generation method according to the ninth embodiment, the arrangement order of the suggested items constituting the suggested item list is changed for each user. A user 1 shown in FIG. 28 is a first user, and a user 2 is a second user. Further, a change of the arrangement order of the suggested items for each presentation is an example of a change of the arrangement order of the suggested items for each presentation.

FIG. 28 shows an example in which the suggested item list IL120 is presented to the first user and the suggested item list IL122 is presented to the second user. The suggested item list IL120 and the suggested item list IL122 shown in FIG. 28 are the same as the suggested item list IL120 and the suggested item list IL122 shown in FIG. 27.

Further, the specific example of the evaluation value shown in FIG. 28 corresponds to a case where the first-time shown in FIG. 27 is replaced with the first user and the second-time is replaced with the second user. Here, a description of a specific example of the evaluation value will be omitted.

The suggested item list generation method according to the ninth embodiment can provide suggestion information of constant quality or higher on average for all users by changing the arrangement order of the suggested items in the suggested item list for each user. Even in a case where the suggested item list is presented once to each user, it is preferable that the arrangement order of the suggested items in the suggested item list can be changed.

Suggested Item List Generation Method According to Tenth Embodiment

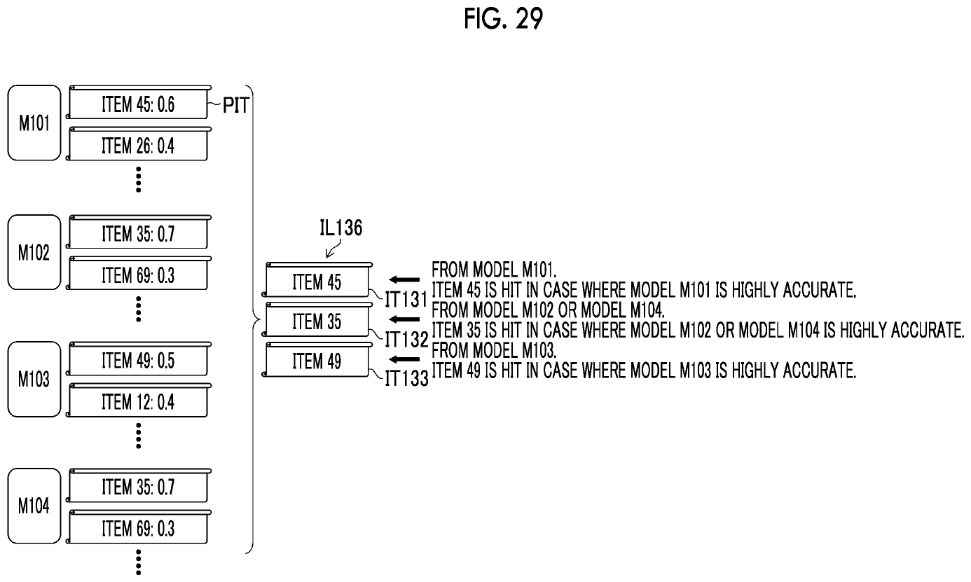

FIG. 29 is a schematic diagram showing a suggested item list generation method according to a tenth embodiment. In the suggested item list generation method according to the tenth embodiment, for the plurality of models, in a case where a model is present that has a high similarity, a suggested item is selected from one candidate item of the similar model, and a suggested item is not selected from the candidate item of the other model. That is, the suggested item is selected with priority from the candidate item list obtained from the dissimilar model.

The candidate list obtained from each of the similar models is an example of a similar candidate list, and the candidate list obtained from each of the dissimilar models is an example of a dissimilar candidate list.

In FIG. 29, a model M102 and a model M104 are exemplified as models having high similarity. The suggested item list IL136 includes a suggested item IT131 in which the candidate item of the model M101 is selected and a suggested item IT133 in which the candidate item of the model M103 is selected.

Further, the suggested item list IL136 includes the suggested item IT122 from which the candidate item of the model M102 or the candidate item of the model M104 is selected. FIG. 29 illustrates a case where the item 35 of the model M102 or the item 35 of the model M104 is selected as the suggested item IT132.

The similarity of the model can be determined based on the similarity between domains, the similarity of the generated suggested item lists, and the like. For example, the following procedure may be applied to the evaluation of the similarity of the domains corresponding to learning data from the model M101 to the model M104 shown in FIG. 29.

First, the characteristic of each domain is extracted from the dataset of the user attribute and the item attribute. For example, the average age of the users is extracted from the user attribute. The average price of items is extracted from the item attribute. The characteristic of the domain extracted from the dataset may be a statistical value, a distribution, or the like extracted from metadata such as explanatory variables.

Next, the characteristic of each domain is extracted from external information different from the dataset. For example, as related information outside the dataset, a floor area of the facility that is the domain, an average annual household income of the municipality where the facility is located, and the like are extracted.

Next, the characteristic of each domain is represented as a multidimensional vector by using a plurality of types of numerical values representing the characteristic obtained in the above process. For example, the characteristic of each domain is represented as a four-dimensional characteristic vector with the average age of the users, the average price of the items, the floor area of the facility, and the average annual household incomes of the facility where the facility is located as variables.

Next, the similarity degree of the characteristic vectors in the above-described vector space is obtained. In evaluating the similarity degree of the characteristic vector, a value of each dimension of the characteristic vector is standardized, and a numerical range of the value of each dimension is aligned.

Next, the Euclidean distance between the characteristic vectors of each domain is obtained. Domains in which the Euclidean distance between the characteristic vectors is less than a predetermined distance can be determined to be similar domains. It should be noted that the determination of a similarity of the models is not limited to the above example. For example, an aspect may be applied in which the characteristic of each domain is used as a multidimensional vector, the external information is not used as a parameter, and only the explanatory variable is used as a parameter.

The suggested item list generation program 120 shown in FIG. 17 may include a selection program that selects the suggested item from the candidate items based on the similarity between the domains. The selection program may include a similarity determination program that determines the similarity between the domains.

Suggested Item List Generation Method According to Eleventh Embodiment

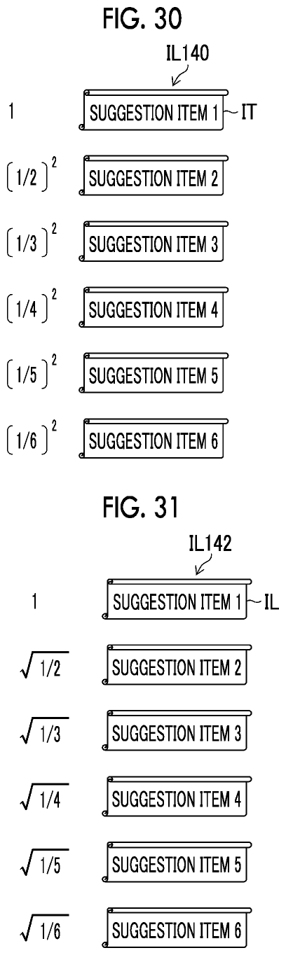

FIG. 30 is a schematic diagram showing an example of a suggested item list generated by applying the suggested item list generation method according to an eleventh embodiment. In the suggested item list generation method according to the eleventh embodiment, weights based on a ranking order of the suggested items are defined according to the user.

FIG. 30 illustrates an example of a suggested item list IL140 including the six suggested items IT of the suggested item 1 to the suggested item 6. An example will be shown in which the square of the reciprocal of the ranking order is applied as the weight whose attenuation becomes relatively large as the ranking order goes down assuming that a higher ranking suggested item such as a suggested item 1 in the suggested item list IL 140 are often browsed, and a user who does not often browse a lower ranking suggested item such as a suggested item 6.

FIG. 31 is a schematic diagram showing another example of the suggested item list generated by applying the suggested item list generation method according to the eleventh embodiment. In FIG. 31, the suggested item list IL 142 having a different weight, which is obtained based on the ranking order, from the IL 140 shown in FIG. 31 is illustrated.

An example will be shown in which the square root of the reciprocal of the ranking order is applied as a weight whose attenuation becomes relatively smaller as the ranking order goes down assuming that a user browses all the suggested items IT, from the higher ranking suggested item IT such as the suggested item 1, to the lower ranking suggested item IT such as the suggested item 6 in the suggested item list IL142.

First Specific Example of Plurality of Models

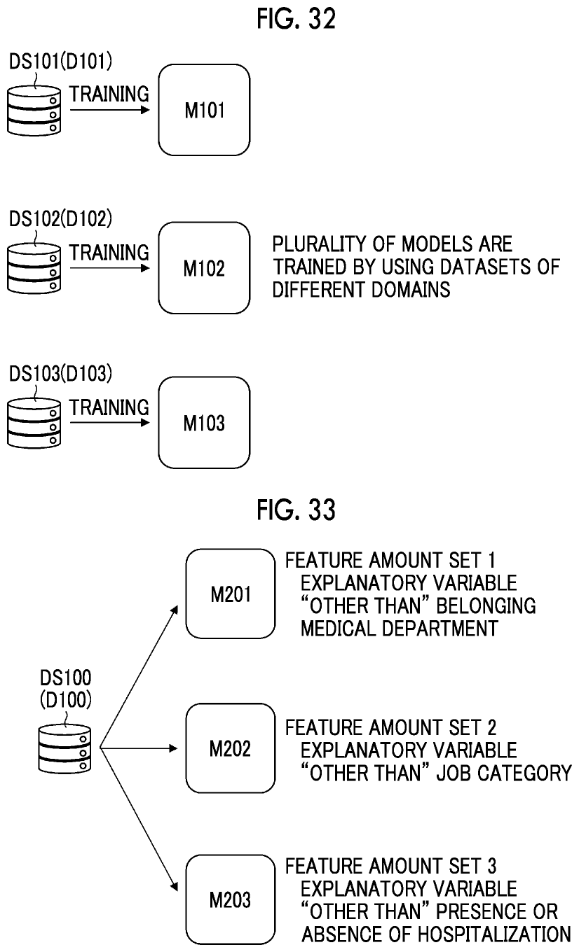

FIG. 32 is an explanatory diagram of a first specific example of a plurality of models. The plurality of models, which output candidate items and are different from each other, are trained by applying datasets in different domains as learning data.

FIG. 32 illustrates the model M101, which is a trained model that is trained by using a dataset DS101 of a domain D101, the model M102, which is a trained model that is trained by using a dataset DS102 of a domain D102, and the model M103, which is a trained model that is trained by using a dataset DS103 of a domain D103.

Second Specific Example of Plurality of Models

FIG. 33 is an explanatory diagram of a second specific example of a plurality of models. It is considered a case where a dataset DS100 is acquired from one domain D100 without being able to acquire datasets from a plurality of domains that are different from each other.

For the datasets acquired from one domain, a plurality of feature sets different from each other are extracted, and a training is performed using the plurality of feature sets different from each other as the learning data, and then a plurality of models different from each other are generated.

FIG. 33 illustrates a model M201, which is generated by using a first feature set extracted from the dataset of one domain, a model M202, which is generated by using a second feature set, and a model M203, which is generated by using a third feature set. It should be noted that each of the feature set 1, the feature set 2, and the feature set 3 illustrated in FIG. 33 corresponds to a first feature set, a second feature set, and a third feature set.

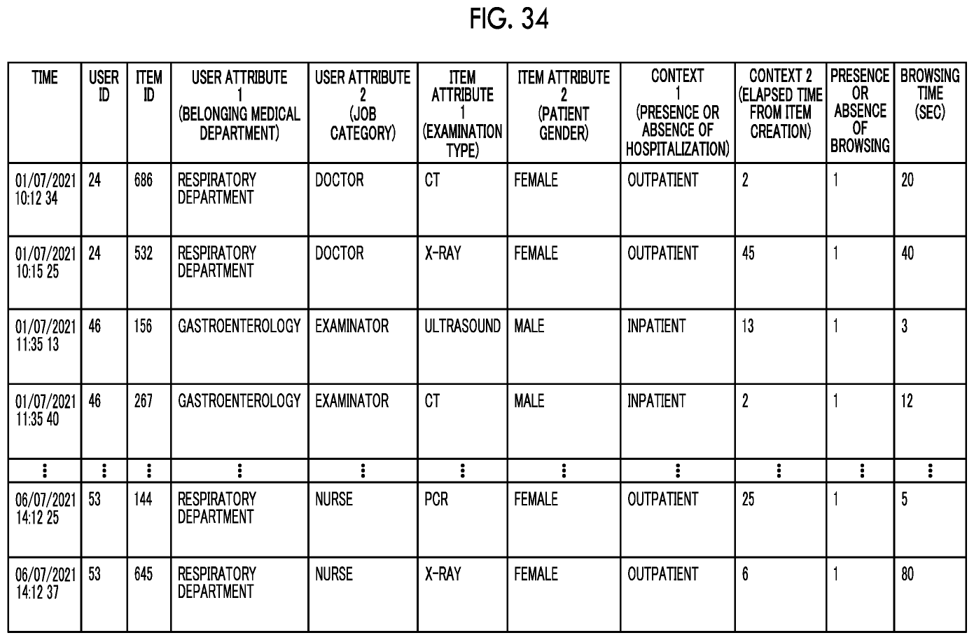

FIG. 34 is a list of variables. FIG. 34 illustrates a user attribute, an item attribute, and a context as variables that can be used as the explanatory variables. In FIG. 34, a belonging medical department such as a respiratory department is exemplified as a user attribute 1, and a job category such as a doctor is exemplified as a user attribute 2.

Further, in FIG. 34, the examination type such as CT is exemplified as an item attribute 1, a patient gender is exemplified as an item attribute 2, the presence or absence of hospitalization is exemplified as a context 1, and the elapsed time from item creation is exemplified as a context 2. Note that, CT is an abbreviation for Computed Tomography.

For example, as the feature set applied to the learning data of the model M201 in FIG. 33, an explanatory variable other than the belonging medical department can be applied. The model M201 has constant robust performance even in a case where a relation between the belonging medical department and browsing is changed.

As the feature set applied to the learning data of the model M202, an explanatory variable other than the job category can be applied. The model M202 has constant robust performance even in a case where a relation between the job category and browsing is changed.

As the feature set applied to the learning data of the model M203, an explanatory variable other than the presence or absence of hospitalization can be applied. The model M202 has constant robust performance even in a case where a relation between the presence or absence of hospitalization and browsing is changed.

It is assumed that a part of the relation between the explanatory variable and the response variable is changed due to the domain shift. However, it is difficult to grasp which explanatory variable of the relation with the response variable is changed. Therefore, a plurality of models are prepared in which any one of the plurality of models is appropriate even in a case where any of the explanatory variables of the relation with the response variable is changed.

### Effects of Embodiment

The information processing apparatus and the information processing method according to the embodiment can obtain the following effects.
[1]

In an information processing apparatus that performs an information suggestion for suggesting a plurality of suggested items to a user, one or more candidate items are acquired from each of a plurality of models, which are a plurality of models different from each other and are trained by using datasets different from each other as learning data. From among the plurality of candidate items, a plurality of candidate items including candidate items of models that are different from each other are selected as suggested items.

As a result, a suggested item list having robust performance against a domain shift is generated.
[2]

The candidate items are arranged in descending order of prediction values of the candidate items for each of the plurality of models, and the suggested items are selected in order from the highest ranking candidate item of each model. As a result, a candidate item to be a suggested item is selected from each model in a well-balanced manner.
[3]

In a case where the size of the suggested item list is larger than the number of models, a weight based on a ranking order of the candidate items is considered in a case where the suggested item is selected.
[4]

A statistical value of the prediction values in each model for each candidate item is used as a prediction value of the candidate item. The suggested items are selected in descending order of the prediction values. As a result, a candidate item to be a suggested item is selected from each model in a well-balanced manner.
[5]

A plurality of candidate lists consisting of the plurality of suggested items that include one or more suggested items selected from each model are generated, and a plurality of evaluation values, in which a closeness of attributes between a domain of an introduction destination facility and a domain of each model is different, are calculated for each of the plurality of candidate lists. A candidate list in which the minimum value of the evaluation values is the largest is extracted for each evaluation condition and is used as the suggested item list. Accordingly, the suggested item list having the robust performance against the domain shift is extracted based on the evaluation value of the candidate list.
[6]

In a case where the suggested item list is provided to the same user a plurality of times, an arrangement order of the suggested items in each time of the suggested item list can be changed. As a result, the suggested item list of constant quality is provided to the target user on average.
[7]

The arrangement order of the suggested items in the suggested item list can be changed for each user. As a result, the suggested item list of constant quality is provided to all users on average.
[8]

From among the plurality of models, in a plurality of models having relatively high similarity, one of the respective candidate items is selected as the suggested item. As a result, a candidate item to be a suggested item is selected from each model in a well-balanced manner.
[9]

The weight can be changed according to a ranking order of the candidate list in accordance with the characteristic of the user. As a result, the evaluation value of the candidate list in consideration of the characteristic of the user is calculated.

A trained model, which is trained by using datasets of domains different from each other, is applied to each of the plurality of models. As a result, candidate items that can correspond to a wide variety of domains are acquired.

The trained model, which is trained by using a plurality of feature sets different from each other in a dataset of one domain, is applied to each of the plurality of models. Thereby, even in a case where the datasets of the plurality of domains cannot be used, the candidate items that can correspond to a wide variety of domains are acquired.

The technical scope of the present invention is not limited to the scope described in the above-described embodiment. The configurations and the like in each embodiment can be appropriately combined between the respective embodiments without departing from the spirit of the present invention.

### EXPLANATION OF REFERENCES

10: suggestion system
12: prediction model
14: model
100: information processing apparatus
102: processor
104: computer-readable medium
106: communication interface
108: input/output interface
110: bus
112: memory
114: storage
120: suggested item list generation program
140: candidate item storage unit
142: suggested item list storage unit
152: input device
154: display device
160: candidate item acquisition unit
162: suggested item selection unit
164: suggested item list generation unit
D101: domain
D102: domain
D103: domain
DS1: dataset
DS2: dataset
DS3: dataset
DS101: dataset
DS102: dataset
DS103: dataset
DS110: dataset
DS112: dataset
Dtg: data
IT: suggested item
IT1: item
IT2: item
IT3: item
IT101: suggested item
IT102: suggested item
IT131: suggested item
IT132: suggested item
IT133: suggested item
IT201: suggested item
IT202: suggested item
IT203: suggested item
IT204: suggested item
IT205: suggested item
IT206: suggested item
IT301: suggested item
IT302: suggested item
IL: suggested item list
IL100: suggested item list
IL102: suggested item list
IL104: suggested item list
IL110: suggested item list
IL112: suggested item list
IL114: suggested item list
IL120: suggested item list
IL122: suggested item list
IL136: suggested item list
IL140: suggested item list
IL142: suggested item list
M1: model
M2: model
M3: model
M101: model
M102: model
M103: model
M201: model
M202: model
PIL100: candidate list
PIL102: candidate list
PIT: candidate item
S10 to S14: each step of information processing method

What is claimed is:

1. An information processing method of causing an information processing system, which includes one or more processors, to generate a suggested item list for suggesting a plurality of items to a user, the information processing method comprising:
causing the information processing system to execute:
acquiring one or more candidate items from each of a plurality of models trained by using datasets in one or more domains different from an introduction destination domain; and
selecting, from among a plurality of the acquired candidate items, a plurality of candidate items having different domains from each other as suggested items and generating a suggested item list that is a suggested item list including a plurality of the suggested items and that has robust performance against a domain shift.

2. The information processing method according to claim 1,
wherein the information processing system is configured to:
calculate a prediction value obtained by predicting a user behavior with respect to each of the candidate items; and
select the suggested item from the plurality of candidate items based on an order of statistical values calculated by using the prediction value of the same candidate item in each of a plurality of domains different from the introduction destination domain.

3. The information processing method according to claim 1,
wherein the information processing system is configured to:
derive an evaluation value obtained in accordance with a closeness of attributes between the introduction destination domain and each of a plurality of domains, for each of a plurality of candidate lists that are candidates for the suggested item list; and
define the candidate list for which a minimum value of the evaluation values is the largest, as the suggested item list.

4. The information processing method according to claim 3,
wherein the information processing system is configured to calculate, assuming that a user behavior is positive on the candidate item of the model trained by using data of a domain having an attribute close to an attribute of the introduction destination domain and assuming that the user behavior is negative on the candidate item of the model trained by using data of a domain having an attribute distant from the attribute of the introduction destination domain, the evaluation value for each of the candidate lists by deterministically simulating the user behavior.

5. The information processing method according to claim 3,
wherein the information processing system is configured to calculate, assuming that a user behavior is positive with a first probability on the candidate item of the model trained by using a dataset of a domain having an attribute close to an attribute of the introduction destination domain as learning data and assuming that the user behavior is positive with a second probability on the candidate item of the model trained by using a dataset of a domain having an attribute distant from the attribute of the introduction destination domain as learning data, the evaluation value for each of the candidate lists by probabilistically simulating the user behavior.

6. The information processing method according to claim 5,
wherein the information processing system is configured to:
estimate the first probability by using an evaluation result obtained by evaluating each of the plurality of models in a first domain to which the dataset is applied as the learning data; and
estimate the second probability by using an evaluation result obtained by evaluating each of a plurality of models in a second domain different from the first domain.

7. The information processing method according to claim 3,
wherein the information processing system is configured to calculate the evaluation value based on a user behavior in a case where the candidate list is presented to the user in the introduction destination domain.

8. The information processing method according to claim 3,
wherein the information processing system is configured to calculate the evaluation value for each of the candidate lists by applying a weight that is a weight defined for each of the candidate items according to an order of the candidate item included in the candidate list and that is defined according to an evaluation condition.

9. The information processing method according to claim 3,
wherein the information processing system is configured to select one or more of the candidate items from each of the plurality of the candidate lists.

10. The information processing method according to claim 1,
wherein the information processing system is configured to select the candidate item to be the suggested item with a priority given to the dissimilar candidate list from among the plurality of candidate lists.

11. The information processing method according to claim 1,
wherein the information processing system is configured to change, in a case where a plurality of presentations of the suggested item list are performed to the same user, an arrangement order of the plurality of suggested items included in the suggested item list for each of the presentations.

12. The information processing method according to claim 1,
wherein the information processing system is configured to change, in a case where a plurality of presentations of the suggested item list are performed, an arrangement order of the plurality of suggested items included in the suggested item list for each of the presentations.

13. The information processing method according to claim 1,
wherein the information processing system is configured to apply, as the plurality of models, a trained model that is trained by using datasets in different domains from each other as learning data.

14. The information processing method according to claim 1,
wherein the information processing system is configured to apply, as a plurality of models, a trained model that is trained by using feature sets different from each other in one domain different from the introduction destination domain as learning data.

15. An information processing system that generates a suggested item list for suggesting one or more items to a user, the information processing system comprising:
one or more processors; and
one or more memories in which a program executed by the one or more processors is stored,
wherein the one or more processors are configured to execute a command of the program to:
acquire one or more candidate items from each of a plurality of models trained by using datasets in one or more domains different from an introduction destination domain; and
select, from among a plurality of the acquired candidate items, a plurality of candidate items having different domains from each other as suggested items and generate a suggested item list that is a suggested item list including a plurality of the suggested items and that has robust performance against a domain shift.

16. A non-transitory, computer-readable tangible recording medium which records thereon a program for generating a suggested item list for suggesting one or more items to a user, the program for causing, when read by a computer, the computer to realize:
a function of acquiring one or more candidate items from each of a plurality of models trained by using datasets in one or more domains different from an introduction destination domain; and
a function of selecting, from among a plurality of the acquired candidate items, a plurality of candidate items having different domains from each other as suggested items and generate a suggested item list that is a suggested item list including a plurality of the suggested items and that has robust performance against a domain shift.
